(19) United States
(12) Patent Application Publication
(10) Pub. No.: US 2024/0338419 A1
(43) Pub. Date: Oct. 10, 2024

(54) METHOD AND APPARATUS FOR SPARSE INPUT-OUTPUT INDEX GENERATION OF SPARSE CONVOLUTION

(71) Applicant: IUCF-HYU(INDUSTRY-UNIVERSITY COOPERATION FOUNDATION HANYANG UNIVERSITY), Seoul (KR)

(72) Inventors: Minjae Lee, Seoul (KR); Janghwan Lee, Seoul (KR); Jun Won Choi, Seoul (KR); Jungwook Choi, Seoul (KR)

(21) Appl. No.: 18/744,717

(22) Filed: Jun. 17, 2024

Related U.S. Application Data
(63) Continuation of application No. PCT/KR2022/021235, filed on Dec. 23, 2022.

(30) Foreign Application Priority Data
Dec. 24, 2021 (KR) 10-2021-0186873
Jun. 27, 2022 (KR) 10-2022-0078048
Dec. 22, 2022 (KR) 10-2022-0182353

(51) Int. Cl. G06F 17/15

(52) U.S. Cl. CPC G06F 17/15

(57) ABSTRACT

A method of convolution operation based sparse data using artificial neural network comprises: a step of extracting index information, location information about a valid data where actual data exists in an input data; a step of generating first location information including computable row information where actual operations are performed in a kernel based on a path along which the kernel moves to perform a convolution operation on the input data and the index information; a step of generating second location information including computable column information where an actual operation is performed in the kernel based on the first location information, the index information, and the kernel size; a step of generating an operation rule for each point of the valid data and convolution output data based on the index information, and the first and second location information; and a step of performing the convolution operation based on the operation rule.

### TECHNICAL FIELD

The present invention relates to a convolution operation method and device based on sparse data using an artificial neural network. More specifically, in performing a convolution operation using an artificial neural network, the present invention analyzes the relationship between input data and output data using the characteristics of the kernel, and then creates rules based on the analysis results. This is an invention regarding a technology that performs convolution operations more quickly.

### BACKGROUND ART

Artificial Intelligence (AI) technology refers to technology that realizes human learning ability, reasoning ability, perception ability, and natural language understanding ability through computer programs. The artificial Intelligence (AI) technology is unlike conventional rule-based smart systems, it refers to a system in which machines learn, make decisions, and become smarter on their own.

Artificial intelligence technology consists of machine learning (deep learning) and element technologies using machine learning. Machine learning is an algorithmic technology that classifies/learns the characteristics of input data on its own, and elemental technology is a technology that uses machine learning algorithms such as deep learning to mimic the functions of the human brain such as cognition and judgment, including linguistic understanding and visual. It consists of technical areas such as understanding, reasoning/prediction, knowledge expression, and motion control.

Artificial intelligence technology is applied and utilized in a variety of fields, including language understanding that recognizes and applies/processes human language/characters, object tracking by recognizing objects as if they were human vision, person recognition, spatial understanding, scene understanding, etc. There is a field of visual understanding, a field of inference/prediction that judge information and makes logical inferences and predictions.

With the development of artificial intelligence technology, artificial intelligence technology is also being applied in the field of autonomous driving to recognize objects around a running vehicle. Specifically, Lidar/RGB-D sensor-based object recognition methods are mainly used. The Lidar/RGB-D sensor-based object recognition method utilizes data in the form of a point cloud to identify objects that exist around the vehicle. By distinguishing the location and type of point cloud data, convolution operations are repeatedly performed on multiple layers to extract features that can classify objects in the data.

However, due to the nature of the object recognition method, since the point cloud data exists sparsely in space, the convolution operation is also performed on the sparse data. Therefore, the features extracted for each layer are stored irregularly in memory, which forces irregular access to load feature data used in convolution operations from memory. Therefore, when performing a convolution operation according to the prior art, there is a problem that the time required to complete the entire process increases significantly.

### DISCLOSURE

### Technical Problem

A convolution operation method and device based on sparse data using an artificial neural network according to an embodiment is an invention designed to explain the problems described above, and it has a purpose to providing a method and device that can efficiently perform convolution operation on sparse data.

More specifically, the present invention generates mapping information between input location information of valid data where real data exists in sparse input data and location information of output data according to the calculation process, and the purpose of the present invention is performing convolution operation more efficiently based on the mapping information.

In addition, the method and device for convolution calculation based on sparse data using an artificial neural network according to an embodiment has a purpose to provide the method and device for generating calculation rules between the input location information of valid data where real data exists in sparse input data and the location information of output data, and effectively performing convolution operations according to the generated rule.

### Technical Solution

A method of convolution operation based sparse data using artificial neural network that performs convolution operations using processor and memory comprises an index information extraction step of extracting index information, which is location information about a valid data where actual data exists in an input data, a first location information generation step of generating a first location information including a computable row information in which actual operations are performed in the kernel based on a path along which a kernel moves to perform a convolution operation on the input data and the index information, a second location information generation step of generating second location information including a computable column information in which an actual operation is performed in the kernel based on the first location information, the index information, and the size of the kernel, an operation rule generation step of generation an operation rule for each point of the valid data and convolution output data based on the index information, the first location information, and the second location information and a convolution operation step of performing a convolution operation based on the operation rule.
wherein the first location information generation step includes a step of sequentially generating the first location information for each row of the input data.
wherein the first location information is generated as a matrix with the same size as the input data.
wherein the first location information includes a first kernel mapping information in which the computable row information is organized by point.
wherein the first location information includes a first input mapping information including information on the valid data corresponding to the first kernel mapping information.
wherein the second location information generating step generates the computable column information based on the first kernel mapping information, the size of the kernel, and the index information.
wherein the second location information includes a second kernel mapping information in which the computable row information and the computable column information are configured for each point.
wherein the second location information includes a second input mapping information including information on the valid data corresponding to the second kernel mapping information.
wherein the operation rule generation step includes a step of generating a rule that matches the second kernel mapping information and the second input mapping information for each point of the convolution operation output data, and then performing a convolution operation based on the rule.
wherein the kernel includes a matrix of size 3×3, 4×4 or 5×5.

A method of convolution operation based sparse data using artificial neural network that performs convolution operations using processor and memory comprises an input data collection step of collecting an information on a valid data related to rows of an output data by performing a convolution operation on an input data by dividing the information by rows of the output data, an extended row information generation step of generating extended row information and an input index information for the valid data based on a column information where the valid data is located within the range of input data corresponding to the movement path of a kernel, an operation rule generation step of generating a location information of output data based on the extended row information and a convolution operation rule based on the input index information, the extended row information, and the location information, a convolution operation step of performing a convolution operation based on the operation rule.
wherein the input data collection step includes a step of collecting input data for overlapping rows using data that has already been collected, considering location information between the row for which input data is to be collected and the row for which input data has already been collected.
wherein the input data collection step includes a step of sequentially collecting and storing the input data for overlapping rows through a pipeline.

The method of convolution calculation based sparse data using artificial neural network further comprises an index information extraction step performed before the input data collection step, and wherein the index information extraction step includes a step of extracting index information, which is location information about valid data in which data exists and invalid data in which data does not exist, within the input data.
wherein the index information extraction step extracts index information using CSR FORMAT information.
wherein the extended row information generation step includes a step of sequentially generating the extended row information at each corresponding column location, starting from the valid data located in the smallest column among the valid data existing within the range of input data corresponding to the movement path of the kernel.
wherein the extended row information generation step includes a step of collecting index information for valid data located in the smallest column among valid data existing within the range of input data corresponding to the movement path of the kernel, divided by row.
wherein the operation rule generation step includes an output index information generation step of generating a reference output index information corresponding to the input index information included in the extended row information,
wherein the output index information generation step includes a step of generating the output index information by expanding it left and right based on the size of the kernel.
wherein the kernel includes a matrix of size 3×3, 4×4 or 5×5.

### Advantageous Effects

In performing a convolution operation based on sparse data using an artificial neural network according to an embodiment, the convolution operation method and device based on sparse data calculates the input data according to a rule generated by considering the location of the input data and the location of the output data. Since the convolution operation is performed only on valid data among the input data, unnecessary operations can be reduced and the convolution operation can be performed faster than the prior art.

Additionally, these features can increase the speed of object recognition in three-dimensional space, enabling efficient high-speed front obstacle recognition essential for high-dimensional autonomous driving, and there is an advantage in that location estimation RGB-D-based robot navigation for fast and accurate robot navigation can also be performed efficiently.

The effects of the present invention are not limited to the technical problems mentioned above, and other effects not mentioned will be clearly understood by those skilled in the art from the description below.

### BRIEF DESCRIPTION OF DRAWINGS

In order to more fully understand the drawings cited in the detailed description of the present invention, a brief description of each drawing is provided.

FIG. 1 is a diagram illustrating a process for performing a convolution operation based on sparse data according to the prior art.

FIG. 2 is a block diagram showing some components of a convolution operation device based on sparse data using an artificial neural network according to an embodiment of the present invention.

FIG. 3 is a diagram showing an example of input data and an example of a kernel as an embodiment of the present invention.

FIG. 4 and FIG. 5 are diagrams for explaining a method of generating first location information according to an embodiment of the present invention.

FIG. 6 and FIG. 7 are diagrams for explaining a method of generating second location information according to an embodiment of the present invention.

FIG. 8 is a diagram expressing the rule finally generated according to an embodiment of the present invention. (a) of FIG. 8 is matrix data indicating the location of the output data, and (b) of FIG. 8 is table shows kernel mapping information and input mapping information matched for each point of the output data.

FIG. 9 and FIG. 10 are diagrams for explaining the actual experimental results of the present invention. FIG. 9 is a diagram explaining the experimental environment, and FIG. 10 is a diagram shows the comparison results of the convolution operation according to the prior art and the convolution operation according to the present invention.

FIG. 11 is a block diagram showing some components of a convolution operation device based on sparse data using an artificial neural network according to another embodiment of the present invention.

FIG. 12, FIG. 13, FIG. 14 and FIG. 15 are diagrams to explain a process in which an input data collection module collects and stores valid data based on input data according to another embodiment of the present invention.

FIG. 16 and FIG. 17 are diagrams for explaining a method in which a row information generation module according to another embodiment generates the 0th row extended row information corresponding to the 0th row of output data.

FIG. 18, FIG. 19, FIG. 20 and FIG. 21 are diagrams for explaining a method in which a row information generation module according to another embodiment generates 1st row extended row information corresponding to the 1^{st} row of output data.

FIG. 22, FIG. 23 and FIG. 24 are diagrams for explaining a method in which a row information generation module according to another embodiment generates the 2nd row extended row information corresponding to the 2nd row of output data.

FIG. 25 and FIG. 26 are diagrams for explaining a method in which a convolution operation module according to another embodiment generates an index rule related to output information of the 0th row of output data for each input index.

FIG. 27, FIG. 28, FIG. 29 and FIG. 30 are diagrams for explaining a method in which a convolution operation module according to another embodiment generates an index rule related to output information of the first row of output data for each input index.

FIG. 31, FIG. 32 and FIG. 33 are diagrams for explaining a process in which a convolution operation module according to another embodiment of the present invention generates an operation rule for the second row of output data.

### MODES OF THE INVENTION

The embodiments described in this specification and the configuration shown in the drawings are preferred examples of the disclosed invention, and at the time of filing this application, there may be various modifications that can replace the embodiments and drawings in this specification.

Additionally, the terms used in this specification are used to describe embodiments and are not intended to limit and/or limit the disclosed invention. Singular expressions include plural expressions unless the context clearly dictates otherwise.

In this specification, terms such as “comprise,” “include,” or “have” are intended to designate the presence of features, numbers, steps, operations, components, parts, or combinations thereof described in the specification. It does not preclude in advance the existence or addition of other features, numbers, steps, operations, components, parts, or combinations thereof.

Additionally, terms including ordinal numbers, such as “first” and “second,” used in this specification may be used to describe various components, but the components are not limited by the terms.

Below, with reference to the attached drawings, embodiments of the present invention will be described in detail so that those skilled in the art can easily implement the present invention. In order to clearly explain the present invention in the drawings, parts unrelated to the description are omitted.

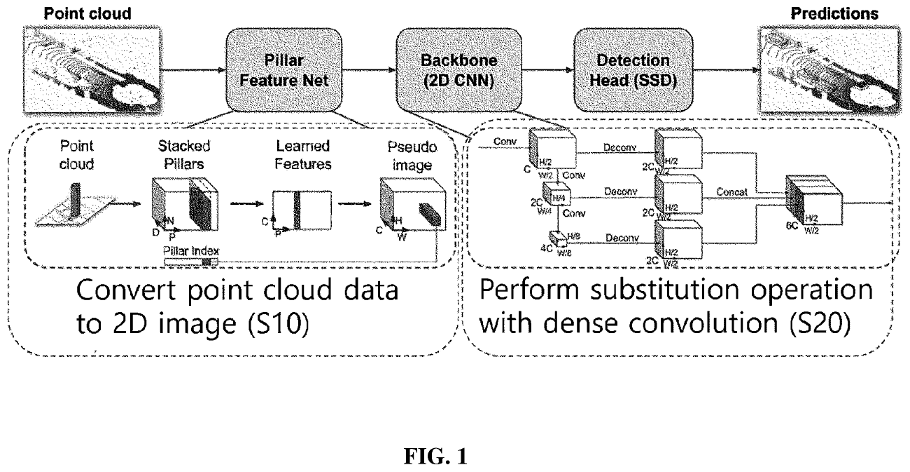

FIG. 1 is a diagram illustrating a process for performing a convolution operation based on sparse data according to the prior art.

Referring to FIG. 1, a point cloud 20 for an object existing in a three-dimensional space obtained through LiDAR has sparse information as shown in the figure. Therefore, the convolution operation is not performed on these data directly, but the input point cloud data is converted into a sparse pseudo image (S10). In other words, the S10 process generates a two-dimensional sparse convolution input data.

However, since performing a convolution operation on sparse image data causes computational inefficiency issues, a convolution operation module converts the sparse image into dense data and then performs a dense convolution operation based on the converted data. However, even if the convolution operation is performed through this process, the sparsity of the sparse data generally exceeds 95%, so the substitution operation for the dense convolution operation has a very inefficient problem.

Therefore, the convolution operation method and device based on sparse data using an artificial neural network according to an embodiment is an invention designed to explain the problem described above and provides a method and device that can efficiently perform convolution operation on sparse data.

More specifically, the present invention has the purpose for generating mapping information between the input location information of valid data where real data exists in sparse input data and the output location information according to the calculation process, and the convolution calculation process is performed more efficiently based on the mapping information. Learn more about the configuration and operating sequence of the present invention through the drawings below.

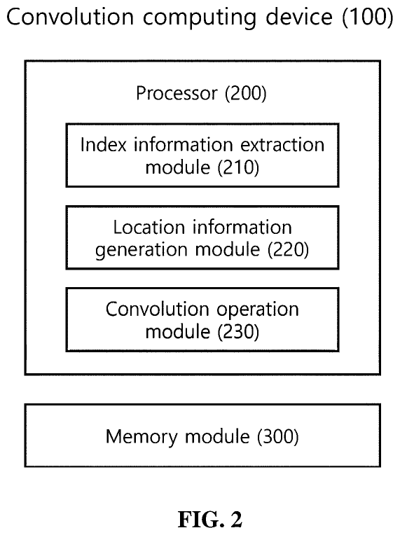

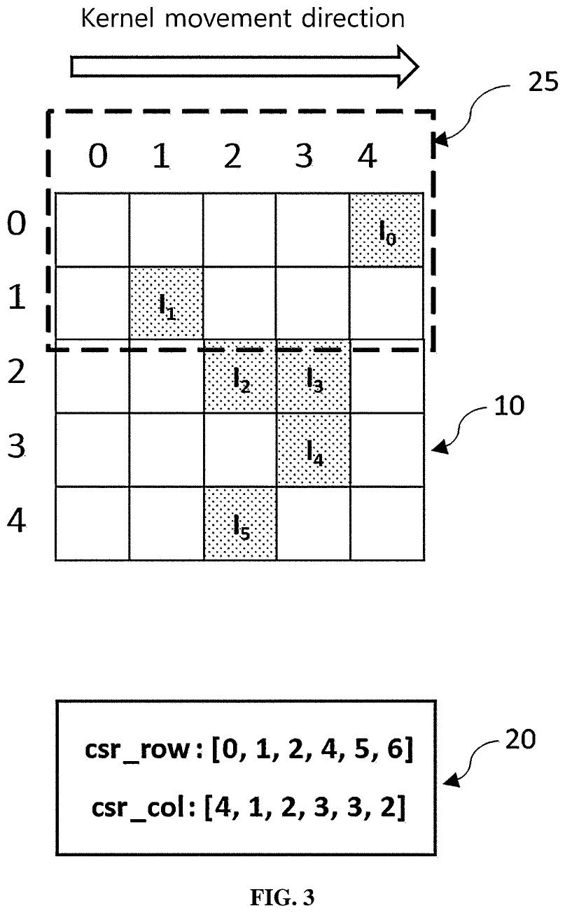

FIG. 2 is a block diagram showing some components of a convolution operation device based on sparse data using an artificial neural network according to an embodiment of the present invention, and FIG. 3 is a diagram showing an example of input data and an example of a kernel as an embodiment of the present invention.

Referring to FIG. 2, a convolution computing device 100 based on sparse data using an artificial neural network according to an embodiment may include a processor 200 and a memory module 300, and the processor 200 includes an index information extraction module 210, a location information generation module 220, and a convolution operation module 230.

The index information extraction module 210 may generate input index information for the input data 10. In the present invention, index information refers to location information about the point where valid data where actual data exists within the input data is located.

As an example, if 5×5 data is input as a input data like FIG. 3 (meaning, the shaded part of the matrix is the area where data exists, and the blank part means the area where data does not exist, and the data at the location where data exists is referred to as valid data), the index information extraction module 210 may extract the location information where the valid data is located within the input data as input index information.

The method of expressing index information can be any known method of expressing matrix data, and a representative example may be the Compressed Spare Row (CSR) format. For convenience of explanation below, index information in the present invention will be described based on the CSR format.

Specifically, the CSR format sequentially contains information about CSR_row, which is information about how many valid data exists in each row, and information about CSR_col, which is information about how many columns of valid data are sequentially located in each row. The CSR format coordinate expression method is generally the same as the matrix expression method, but there is a difference in that it starts at 0 instead of 1.

Therefore, the leftmost and topmost coordinates in the data are not expressed as (1,1) but as (0,0). Therefore, the input data can be viewed as starting rows and columns based on row 0 and column 0, and if the kernel is also a 3×3 matrix kernel, the offset of the kernel is (0, 1, 2) based on rows and (0, 1, 2) based on columns. In other words, both the input data and the kernel are expressed based on row 0.

If we sequentially explain the process of generating index information for the input data shown in FIG. 3, the CSR_row value starts with 0 regardless of the data, and from the second value, the value represents accumulated value by the number of valid data in each row. Therefore, as shown in the figure, CSR_row starts with 0.

Since there is one valid data (I0) in the 0th row, the value of CSR_row considering up to the 0th row is expressed as [0,1].

Since there is one valid data (I1) in the first row, the CSR_row value considering up to the first row is expressed as [0,1,2].

Since there are two valid data (I2, I3) in the second row, the CSR_row value considering up to the second row is expressed as [0,1,2,4].

Since there is one valid data (I4) in the 3rd row, the CSR_row value considered up to the 3rd row is expressed as [0,1,2,4,5].

Since there is one valid data (I5) in the 4th row, the CSR_row value considered up to the 4th row is expressed as [0,1,2,4,5,6].

CSR_col is information that sequentially provides information about which column in each row the valid data is located. Therefore, based on FIG. 3, in the 0th row, data exists in the 4th column, so CSR_col becomes [4], and in the 1st row, since valid data exists in the 1st column, CSR_col becomes [4,1]. In the 2nd row, valid data is in the 2nd and 3rd columns, so CSR_col is [4,1,2,3], and in the 3rd row, the valid data is in the 3rd column, so CSR_col is [4,1,2,3.3]. When data is created in this way, the final CSR_col becomes [4,1,2,3,3,2].

The location information generation module 220 may generate necessary location information for generating rules that can be used in convolution operations based on the index information generated by the index information generation module 210.

Specifically, the location information generation module 220 includes a first location information generation module (not shown) generating the first location information including computable row information on which the actual operation is performed in the kernel based on the path and index information along which the kernel moves to perform the convolution operation on the input data and a second location information generation module (not shown) that generates second location information including operable column information in which actual operations are performed in the kernel based on the index information, and the size of the kernel.

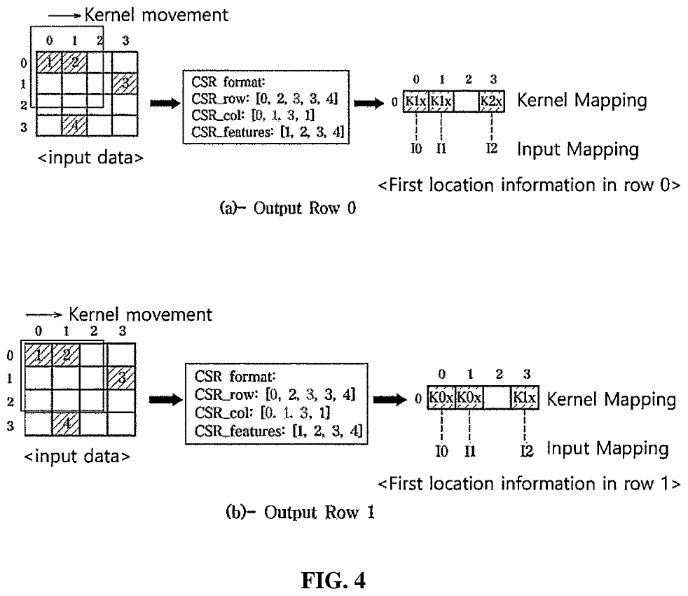

The location information meant in the present invention can be divided into first location information containing row information of the kernel (specific offset of the kernel) on which a convolution operation can be performed on the specifically input valid data, and second location information containing column information of the kernel (specific offset of the kernel) on which the operation can be performed. Therefore, if both the first location information and the second location information are known, when performing, it is possible to accurately know the offset of the valid data and the information about which kernel the operation should be performed on in the convolution operation performed. A more detailed explanation will be provided through FIGS. 4 to 7.

Meanwhile, the kernel moved to perform the convolution operation in the present invention will be described based on the 3×3 kernel as shown in FIG. 3. However, this is only an embodiment of the present invention, and the principles of the present invention can be applied to kernels with sizes such as 2×2, 4×4, 5×5, and the principles of the present invention can be applied as is to a 3D kernel rather than a 2D kernel.

Meanwhile, in the case of a 3×3 kernel, the offset of the kernel in the 0th row is referred to as K00, the offset of the kernel in the 0th row and 1st column is referred to as K01, the offset of the kernel in the 0th row and 2nd column is referred to as K02, the offset of the kernel in the 1st row, 0th column is referred to as K10, the offset of the kernel in the 1st row and 1st column is referred to as K11, and the offset of the kernel in the 1st row and 2nd column is referred to as K12, the offset of the kernel in the 2nd row and 0th column is referred to as K20, the offset of the kernel in the 2nd row and 1st column is referred to as K21, and the offset of the kernel in the 2nd row and 2nd column is referred to as K22.

Returning to FIG. 2 and explaining the convolution operation module 230, the convolution operation module 230 can generate a rule required for a convolution operation based on at least one of the first location information, second location information generated by the location information generation module 220 and the index information generated by the index information extraction module 210 and perfume the convolution operation based on the generated rule.

In FIG. 2, for convenience of explanation, the index information extraction module 210, the location information generation module 220, and the convolution operation module 230 are shown and explained as separate components, but these are separated for convenience of explanation. And one processor 200 may perform the role of each module.

The memory module 300 may store various data necessary for the convolution operation performed by the processor 200. As an example, the index information generated by the index information extraction module 210, the first location information and second location information generated by the location information generation module 220, and the rules generated by the convolution operation module 230 are stored in the memory module 300.

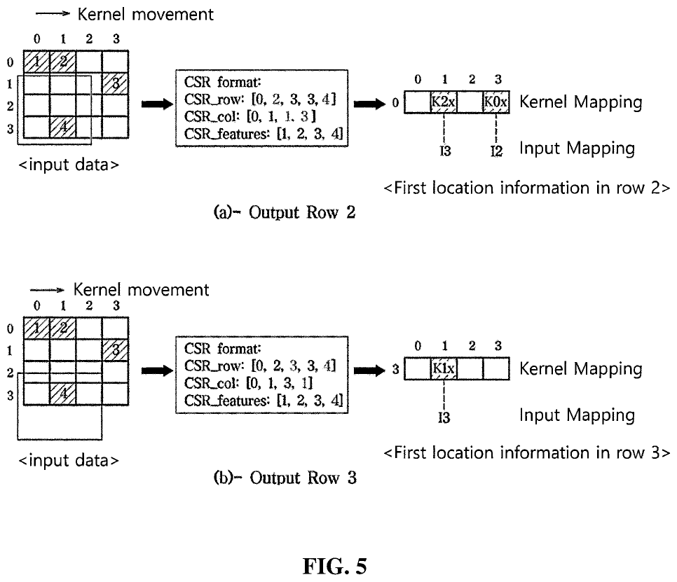

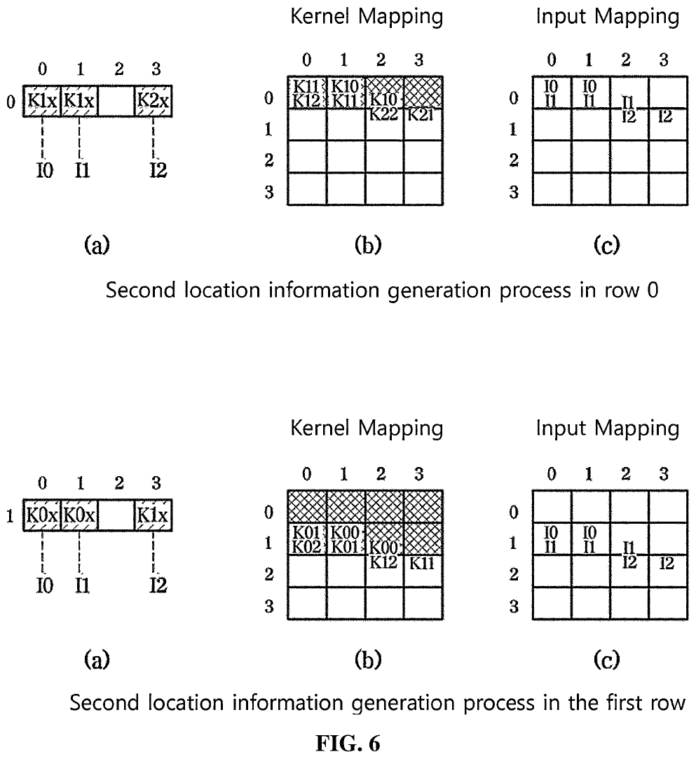

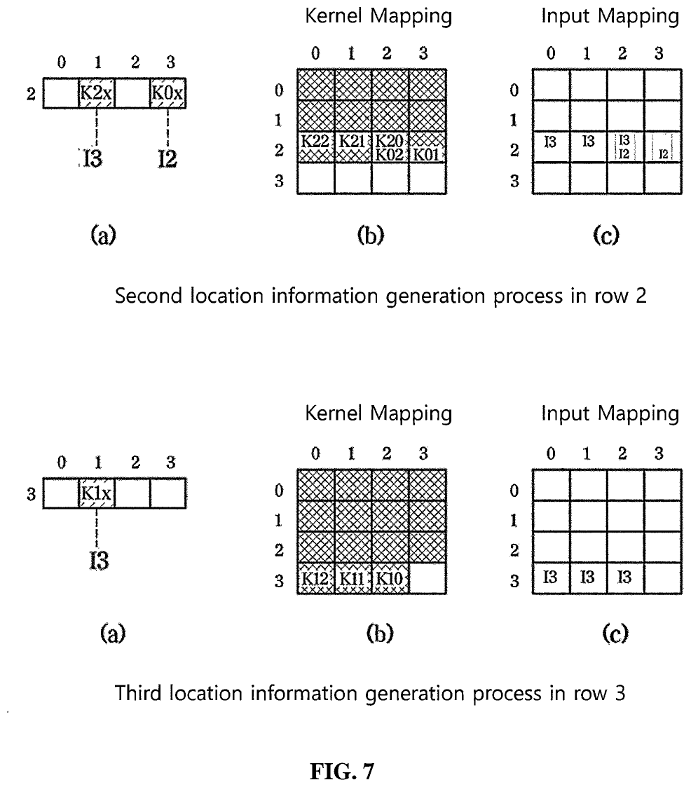

FIGS. 4 to 7 are diagrams for explaining how a convolution computing device performs calculations according to an embodiment of the present invention, and FIG. 4 and FIG. 5 are diagrams for explaining a method of generating first location information according to an embodiment of the present invention, and FIG. 6 and FIG. 7 are diagrams for explaining a method of generating second location information according to an embodiment of the present invention.

In the following specification, for convenience of explanation, first location information is generated and then second location information is generated based on the generated first location information. However, this is only explained this way for convenience of explanation. The embodiment of the present invention is not limited to this, and a method of generating the first location information based on the second location information after generating the second location information may also be an embodiment of the present invention.

In addition, for convenience of explanation, it is assumed that the direction in which the 3×3 kernel moves is assumed to move sequentially from left to right based on the input data (stride=1), and the kernel does not start from 0th row and 0th column of the input data, but is assumed to start with the rows and columns shifted one by one to the left and up (i.e., padding is applied to the outermost rows and columns one by one).

When explaining the process of generating the first location information based on FIG. 4, the input data may be the data on the leftmost part of (a) of FIG. 4, and for convenience of explanation below, valid data in 0th row and 0th column among the input data is referred to as the 0th valid data (I0), valid data in 0th row and 1st column is referred to as 1st valid data (I1), and valid data in 1st row and 3rd column is referred to as second valid data (I2) and valid data in the 3rd row and 1st column will be referred to as third valid data (I3).

When a convolution operation is performed, the kernel first moves with the 0th row of the input data as the central reference axis. In this case, the regions that overlap with the kernel and the input data (I0, I1, I2) on which the convolution operation is performed sequentially become the first row, first row, and second row of the kernel. This means that when the kernel performs a convolution operation centered on the 0th row, the offsets of the 1st row, 1st row, and 2nd row of the kernel will be used in the operation sequentially.

However, the actual convolution operation is performed only in areas where valid data exists. Therefore, when the kernel moves horizontally with 0th row as the central reference axis, the 0th valid data (I0) in the upper leftmost 0th row and 0th row can be predicted that an operation will be performed with at least one of the offsets (K10, K11, K12) in the first row. And this information was expressed as K1x as shown in the drawing.

In other words, K1x can mean information that an operation will be performed with offsets existing in the first row of the kernel, and the information generated in this way is referred to as kernel mapping information.

Meanwhile, in the drawing, the area where kernel mapping information is generated is indicated by a hatched area, and x is a single valid data that is operated a total of three times as the kernel moves due to the nature of the convolution operation, because we do not know exactly which row and column of the first row the operation will be performed, it is expressed as x, an unknown number. As will be explained later, the exact value of x can be determined based on the second location information, and kernel mapping information based on first location information will be referred to as first kernel mapping information, and mapping information based on second location information, which will be described later, will be referred to as second kernel mapping information.

When the kernel passes through the 0th column of the input data and the 1st column, the kernel now overlaps the first valid data (I1), and the convolution operation begins. Since the first valid data (I1) is also located in the 0th column of the input data, it can be seen that an operation will be performed with at least one of the offsets (K10, K11, K12) in the first row of the three rows (0th row, 1st row, and 2nd row) of the kernel.

Therefore, since the row of the kernel where the convolution operation is performed is the first row, the first kernel mapping information for this can be generated as K1x.

When the kernel passes through the first column of input data and then the second column, no valid data exists in the second column, so the convolution operation is not performed based on the second column, and the kernel passes through the second column and then the third column, the second valid data (I2) is in the second row, so the convolution operation can start again.

Specifically, since the second valid data (I2) exists in the first row based on the input data, the operation will be performed with at least one of K20, K21, and K22 which is the offsets in the second row among the three rows (0th row, 1st row, 2nd row) of the kernel. Therefore, since the row of the kernel where the convolution operation is performed is the second row, the first kernel mapping information can be generated as K2x.

Meanwhile, the first location information may include input mapping information along with the first kernel mapping information, and the input mapping information refers to information about valid data on which a convolution operation is performed in correspondence to the first kernel mapping information. For purposes of distinction in the following description, the input mapping information corresponding to the first kernel mapping information will be referred to as first input mapping information, and the input mapping information corresponding to the second kernel mapping information, which will be described later, will be referred to as second input mapping information.

Specifically, input mapping information refers to information about valid data that performs operations with the kernel. K1x, which is the first kernel mapping information in the 0th row and 0th column of the first location information, performs a convolution operation with the 0th valid data (I0) in the 0th row and 0th column of the input data. Therefore, the first input mapping information can be set to correspond to the first kernel mapping information of the 0th row and 0th row as shown in the drawing by using the information about the 0th valid data (I0) as the input mapping information.

If this method is applied sequentially, the first kernel mapping information K1x in the 0th row and 1st column can be connected by matching with the first valid data (I1) in the 0th row and 1st column among the input data, and the first kernel mapping information K2x in the third column can be connected by matching the second valid data (I2) in the first row and third column among the input data with the first input mapping information.

If the first kernel mapping information and the first input mapping information are matched in the same manner as above, when performing the convolution operation, it is possible to easily obtain relationship information about the offsets in which rows of the kernel the valid data (I0, I1, I2) participating in the convolution operation are performing the operation, so there is an advantage to faster operating speed.

When the kernel completes sliding with the 0th row of the input data as the central reference axis, the kernel moves down one row and slides from the left to the right using the 1st row of the input data as the central reference axis, as shown in (b) of FIG. 4.

When the kernel moves around the first row of the input data, the area where the input data (I0, I1, I2) and the kernel overlap for convolution operation is sequentially the 0th row, 0th row, and 1st row of the kernel. This means that when a convolution operation is performed as the kernel moves with the first row as the central reference axis, the data of the 0th row, 0th row, and 1st row of the kernel will be sequentially used for the calculation.

However, since the actual convolution operation is performed only in the area where valid data exists, when the kernel moves horizontally to the 1st row as the central reference axis, the 0th valid data (I0) in the 0th row and 0th column will perform an operation with at least one of the offsets (K00, K01, K02) in row 0 among several rows (0th row, 1st row, 2nd row) of the kernel, it can be expressed as K0x which is shown in the figure.

When the kernel passes through the 0th column of the input data and the 1st column, the kernel now overlaps the first valid data (I1) and the convolution operation begins. Since the first valid data (I1) is also the 0th row of the input data, an operation is performed with the data values in 0th row (at least one of 0th column, 1st column, and 2nd column) among the three rows (0th row, 1st row, and 2nd row) of the kernel.

Accordingly, since the row of the kernel where the convolution operation is performed is the 0th row, the first kernel mapping information of the 1st row and 0th column in the first location information can be generated as K0x.

When the kernel passes through the first column of the first row of input data and the second column of the first row of input data, no valid data exists in the second column, so the convolution operation is not performed based on the second column. If the kernel passes through the second column and the third column, the convolution operation can start because the second valid data (I2) is in the third column.

Specifically, since the second valid data (I2) exists in the first row based on the input data, an operation will be performed with at least one of the offsets (K10, K11, and K12) in the first row among the three rows (0th row, 1st row, 2nd row) of the kernel.

Therefore, since the row of the kernel where the convolution operation is performed is the first row, the first kernel mapping information in the third column of the first location information based on the first row can be generated as K1x.

Meanwhile, the first kernel mapping information in the 0th column of the first kernel mapping information based on the 1st row performs a convolution operation with the 0th valid data (I0) in the 0th row and 0th column of the input data, as seen previously. Therefore, the 0th valid data (I0) is the 1st input mapping information and, as shown in the figure, may correspond to the 1st kernel mapping information in the 1st row and 0th column.

If this method is applied sequentially, since the first kernel mapping information K0x in the first column of the first kernel mapping information based on the first row performs a convolution operation with the first valid data (I1) in the 0th row and 1st column of the input data, the first valid data (I1) can be matched and connected to the first kernel mapping information K0x as the input mapping information, and the first kernel mapping information K1x in the third column can be matched and connected to the second valid data (I2) in the first row and third column among the input data as the first input mapping information.

If the first kernel mapping information and the first input mapping information are matched in the same manner as above, when performing the convolution operation, when performing a convolution operation, based on the valid data (I0, I1, I2), it is possible to easily obtain relationship information about the offsets in which rows of the kernel the valid data are in and the convolution operation is performed. So, there is an advantage that can improve calculation speed.

When the kernel completes sliding with the first row as the central reference axis, the kernel moves down one row and slides from left to right with the second row as the central reference axis, as shown in (a) of FIG. 5. In this case, all the principles described above can be applied as is.

Therefore, as shown in the figure, in the first location information based on the second row, the first kernel mapping information of the first and third columns may be generated as K2x and K0x, respectively, and third valid data (I3) and second valid data (I2) are respectively corresponded to K2x and K0x as first input mapping information.

When the kernel completes sliding with the second row as the central reference axis, the kernel moves down one row and slides from left to right with the third row as the central reference axis, as shown in (b) of FIG. 5. In this case, all the principles described above can be applied as is.

Therefore, as shown in the figure, in the first location information based on the third row, the first kernel mapping information can be generated as K1x only in the first column, and in this case, the third valid data (I3) is used as the first input mapping information, it may correspond to K1x.

So far, we have looked at how to generate first location information. Hereinafter, we will look at a method of generating second location information based on first location information.

FIG. 6 is a diagram expressing second location information based on the 0th and 1st rows according to an embodiment of the present invention, and FIG. 7 is a diagram expressing the second location information based on the 2nd and 3rd rows according to an embodiment of the present invention.

Referring to FIG. 6, the second location information may be converted into second location information such as (b) and (c) of FIG. 6 based on the first location information according to (a) of FIG. 6. The second location information includes information about specific rows participating in the convolution operation that are not included in the first location information.

In general, in the case of a 3×3 matrix, the stride of the kernel is 1, and when the kernel operates while moving from outside of the valid data to the inside of the valid data, one valid point performs a calculation with a total of 3 times while the kernel moves once from left to right. However, in the case of the present invention, since there is padding at both ends of the input data, the data in the first and last columns of the input data (the 0th and 3rd columns based on the example according to the drawing) performs only 2 operations when the kernel from the leftmost column to the right, and valid data existing in the columns between them requires 3 operations.

For example, if the explanation is based on the first location information shown in the upper part (a) of FIG. 6, the 0th valid data (I0) corresponding to the 1st kernel mapping information (K1x) in the 0th column of the 0th row performs a convolution operation with the data in the first row of the kernel. Specifically, the 0th valid data (I0) exists in the 0th column of the input data, so it performs a convolution with the offsets in the first row of the kernel.

However, since the 0th valid data (I0) is in the leftmost column of the input data, a convolution operation is not performed with all offsets in the 1st row, the 0th valid data (I0) performs a convolution operation with K11, which is the offset of the 1st row and 1st column, and K10, which is the offset of the 1st row and 0th column. Therefore, the offset information of the kernel determined in this way was defined as second kernel mapping information and then expressed as shown in the drawing. In addition, for K11 and K10, the offset of each kernel and the information on the valid data used to perform the operation are referred to as second input mapping and are indicated in the drawing.

The first valid data (I1) corresponding to the first kernel mapping information (K1x) in the 1st column of the 0th row of the first location information performs a convolution operation with the data in the 1st row of the kernel. Specifically, since the first valid data (I1) is in the middle column in the input data, as shown in the figure, a convolution operation is performed with K12, which is the offset of the first row and second column of the kernel, and K11, which is the offset of the first row and first column, and K10, which is the offset of the first row and 0th column.

The second valid data (I2) corresponding to the first kernel mapping information (K2x) in the third column of the 0th row of the first location information performs a convolution operation with the offsets in the 2nd row of the kernel. Specifically, since the second valid data (I2) is in the last column in the input data, the operation is not performed with the three offsets of the kernel, and as shown in the figure, the operation is performed with K22, which is the offset of the second row and second column of the kernel, and K21 which is the offset of the second row and first column.

In this way, the second kernel mapping information and the second input mapping information generated for 0th row of the first location information can be finally expressed in the form as shown in (b) and (c) of FIG. 6.

If all the second location information for 0th row of the first location information has been generated, the second location information can be sequentially generated for the next row. If explained based on the first location information shown in the bottom (a) of FIG. 6, the 0th valid data (I0) corresponding to the 1st kernel mapping information (K0x) in the 0th column of the 1st row performs a convolution operation with the data in 0th row.

Specifically, since the 0th valid data (I0) exists in the first column of the input data, a convolution operation is performed with K01, which is the offset of the 0th row and 1st column of the kernel, and K00, which is the offset of the 0th row and 0th column of the kernel.

The first valid data (I1) corresponding to the first kernel mapping information (K0x) in the first column of the first row of the first location information performs a convolution operation with the data in the 0th row of the kernel. Specifically, since the first valid data (I1) is in the middle column in the input data, the convolution operation is performed sequentially with K02, which is the offset of 0th row 0 and 2nd column of the kernel, K01, which is the offset of 0th row and 1st column, and K00, which is the offset of 0th row and 0th column.

The second valid data (I2) corresponding to the first kernel mapping information (K1x) in the third column of 0th row of the first location information performs a convolution operation with the data in the first row of the kernel. Specifically, since the second valid data (I2) is in the last column in the input data, without performing the operation with the three offsets of the kernel, and a convolution operation is performed with K12, which is the offset of the first row and second column of the kernel, and K11, which is the offset of the first row and first column.

In this way, the second kernel mapping information and the second input mapping information generated for the first row of the first location information can be finally expressed in the form shown in (b) and (c) below in FIG. 6.

Once all the second location information for the first row of the first location information has been generated, the second location information for the second row, which is the next row, can be sequentially generated.

If explained based on the first location information shown in the upper part (a) of FIG. 7, the third valid data (I3) corresponding to K2x, which is the first kernel mapping information in the first column of the second row, performs a convolution operation with the valid data in second row of the kernel.

Specifically, the third valid data (I3) is data that exists in the middle column of the input data, A convolution operation is performed with the K22, which is the offset of the second row and second column of the kernel, K21, which is the offset of the second row and first column, and K20, which is the offset of the second row and 0th column.

The second valid data (I2) corresponding to K0x, which is the first kernel mapping information in the third column of the 0th row of the first location information, performs a convolution operation with the offsets in the 0th row of the kernel. Specifically, since the second valid data (I2) is in the last column in the input data, the operation is not performed on all three offsets of the kernel, and the operation is performed with K02, which is the offset of the 0th row and 2nd column of the kernel, and K01, which is the offset of the 0th row and 1st column.

In this way, the second kernel mapping information and the second input mapping information generated for the second row of the first location information can be finally expressed in the form as shown in (b) and (c) of FIG. 7.

If all the second location information has been generated for the second row of the first location information, the second location information for the third row, which is the next row, can be sequentially generated.

If explained based on the first location information shown in (a) at the bottom of FIG. 7, the third valid data (I3) corresponding to K1x, which is the first kernel mapping information in the first column of the third row, performs a convolution operation with the offsets in the first row of the kernel.

Specifically, the third valid data (I3) exists in the middle column of the input data, so a convolution operation is performed with K12, which is the offset of the first row and second column of the kernel, K11, which is the offset of the first row and first column, and K10, which is the offset of the first row and 0th column.

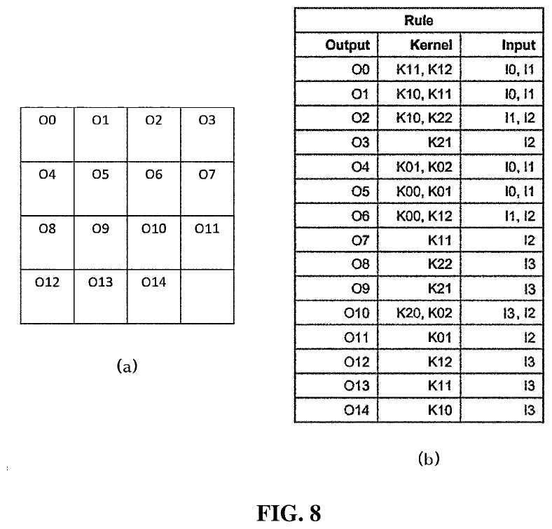

In this way, the second kernel mapping information and the second input mapping information generated for the third row of the first location information can be finally expressed in the form as (b) and (c) of FIG. 7. And the information is ultimately generated as a rule and used to perform convolution operations. Let us find out through FIG. 8.

FIG. 8 is a diagram expressing the rule finally generated according to an embodiment of the present invention. (a) of FIG. 8 is matrix data indicating the location of the output data, and (b) of FIG. 8 is each of the output data. This table shows kernel mapping information and input mapping information matched for each point.

When data in the form of a 4×4 matrix is output as output data as shown in (a) of FIG. 8, a total of 15 points (O0 to O14) can be arranged sequentially as shown in the drawing, and a rule in which each point connected kernel mapping information and input mapping information can be generated. And the convolution operation module 230 can perform a convolution operation based on the rule created in this way.

When performing a convolution operation according to these rules, since the operation is performed by accessing only valid data, there is no need to perform an operation on data that does not affect the result of the convolution operation, so convolution is performed faster than the prior art.

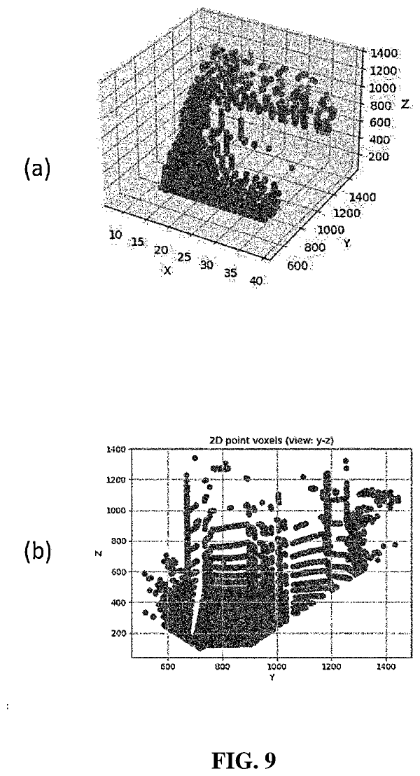

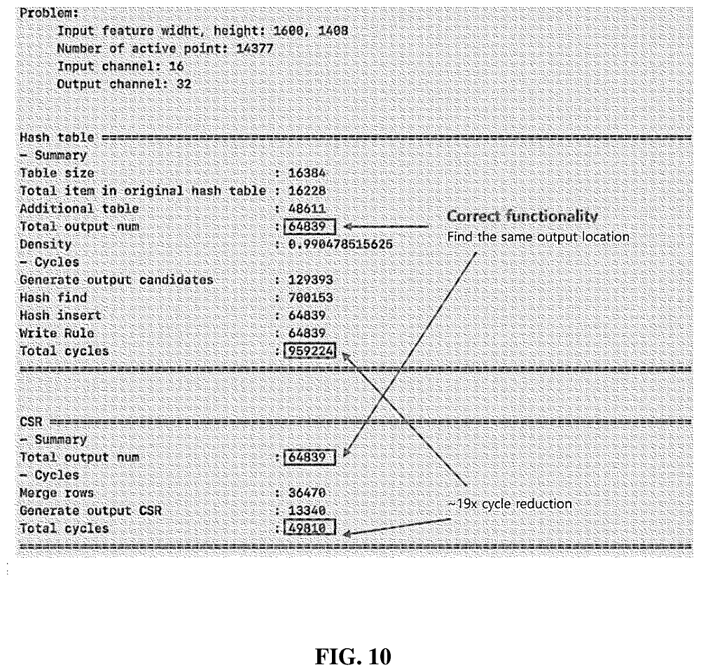

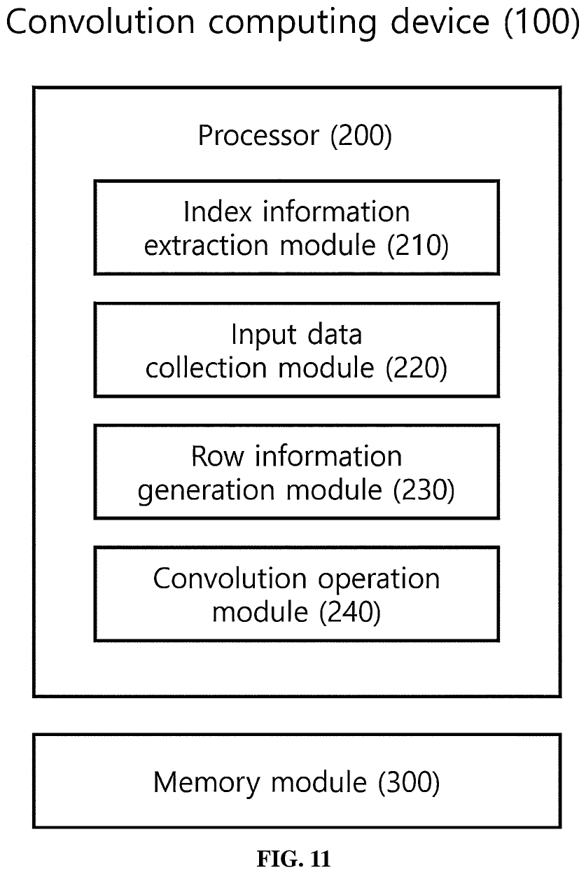

FIGS. 9 and 10 are diagrams for explaining the actual experimental results of the present invention. FIG. 9 is a diagram explaining the experimental environment, and FIG. 10 shows the comparison results of the convolution operation according to the prior art and the convolution operation according to the present invention.
(a) of FIG. 9 is a diagram illustrating a situation in which the number of data is 14,377 in a 3D space with a total of 2,000,000 points (therefore, only 0.7% of the total data is valid data), and (b) of FIG. 9 is converting these data into voxel data in 2D space.

In addition, referring to FIG. 10, when performing a convolution operation according to the prior art in producing the same result as shown in FIG. 10, the number of times the processor had to access the DRAM was 959,224, but in the present invention, the number of times the processor accesses DRAM is 49,810, which means that access to DRAM is reduced by more than 19 times compared to the prior art. Because of this, the processor according to the present invention can perform the convolution operation more efficiently and quickly than the convolution operation according to the prior art.

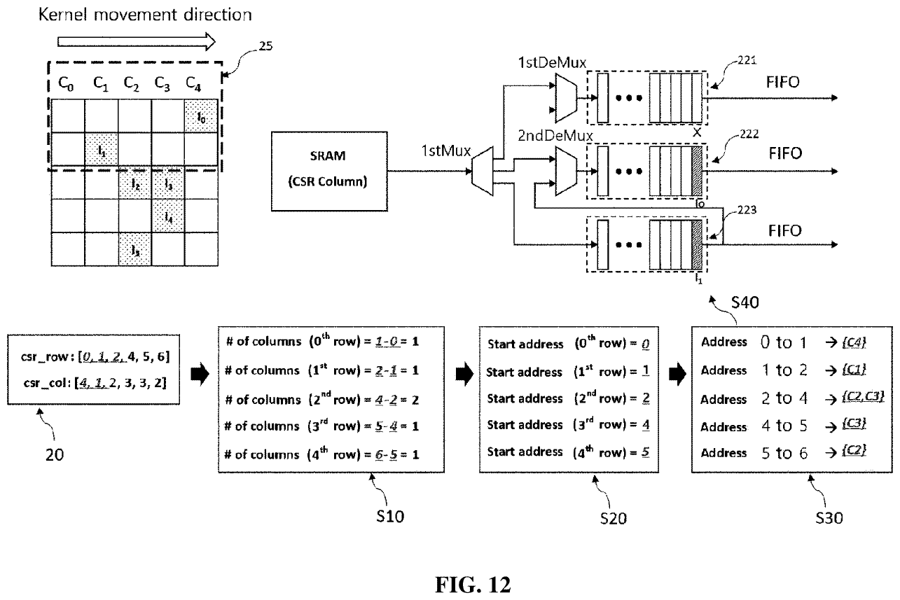

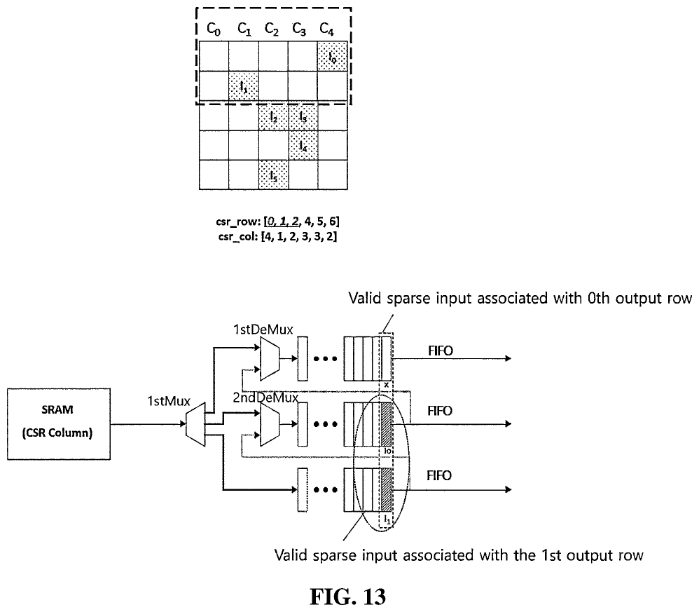

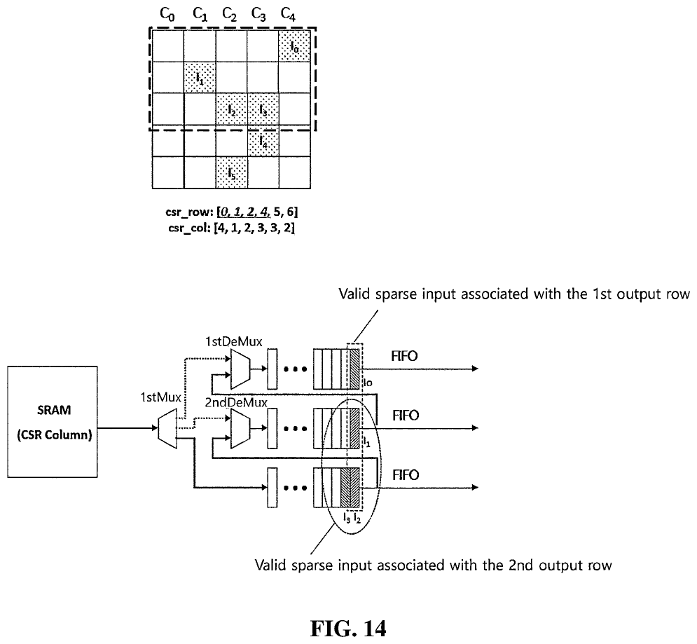

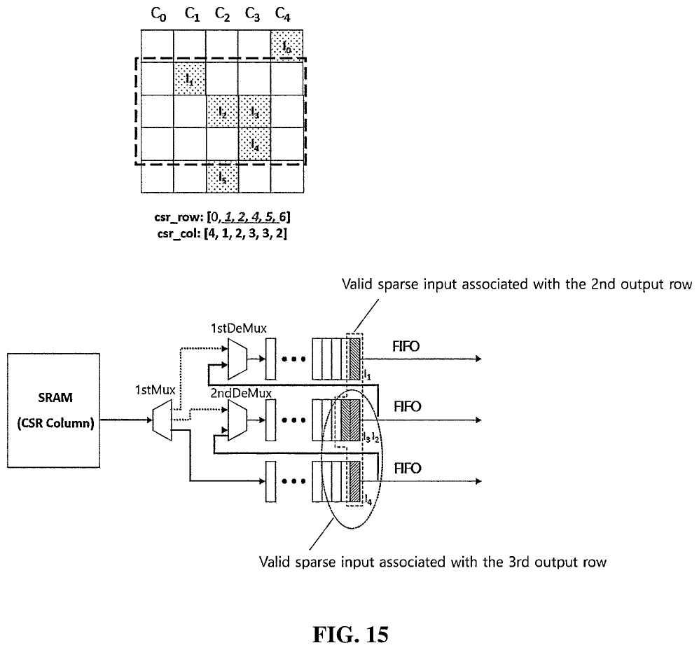

FIGS. 11 to 33 are diagrams explaining a convolution operation device based on sparse data using an artificial neural network according to another embodiment of the present invention. FIG. 11 is a block diagram showing some components of a convolution operation device based on sparse data using an artificial neural network according to another embodiment of the present invention. FIG. 12, FIG. 13, FIG. 14, and FIG. 15 are diagrams to explain a process in which an input data collection module collects and stores valid data based on input data according to another embodiment of the present invention.

Referring to FIG. 11, a sparse data-based convolution operation device using an artificial neural network according to another embodiment may include a processor 200 and a memory module 300, and the processor 200 may include an index information extraction module 210, an input data collection module 220, a row information generation module 230, and a convolution operation module 240.

Meanwhile, the kernel moved to perform the convolution operation in the present invention will be described based on the 3×3 kernel as shown in FIG. 12. However, this is only another embodiment of the present invention, and the principle of the present invention can be applied to kernels with sizes such as 2×2, 4×4, 5×5 and the principles of the present invention can be applied as is to a 3D kernel rather than a 2D kernel.

In addition, in FIG. 11, for convenience of explanation, the index information extraction module 210, the input data collection module 220, the row information generation module 230, and the convolution operation module 240 are shown as separate components. Although described, this is divided for convenience of explanation, and one processor 200 may perform the role of each module, and the configuration and role of the index information extraction module 210 are same as the index information extraction module 210 described in FIG. 2 above. So, its description will be omitted, and the different components will be described in detail.

The input data collection module 220 collects and stores valid data and non-valid data (hereinafter referred to as ‘invalid data’) in the input data based on the input index information generated by the index information generation module 210 with rows by considering the size of the kernel.

Specifically, the input data collection module 220 selects valid data and invalid data within the input data 10 based on the size information and stride path information of the input kernel and the input index information generated by the index information extraction module 220. And the data can be collected row by row and stored sequentially. For example, if the kernel size is 3×3, input data is collected in 3 rows, and if the kernel size is 4×4, input data is collected in 4 rows.

To explain this with reference to FIG. 11, the input data collection module 220 may collect and store valid and invalid data by row included in a row within the input data 10 based on the input index information 20 generated by the index information module 210.

To explain this in stages, the input data collection module 220 first collects the number of valid data for each row by dividing the number of the next column and the number of the previous column in the CSR_row information, which is the input index information 20. (S10)

Specifically, as collected in the drawing, the number of valid data in the nth row can be calculated as csr_row [n+1]−csr_row [n].

For example, the number of valid data in 0th row 0 is csr_row [1]−csr_row [0]=1−0=1, so it can be calculated that there is 1 valid data.

In this way, the number of valid data in the first column is 1, csr_row [2]−csr_row [1]=2−1, and the number of valid data in the second row is 2, which is 4 minus 2. And the number of valid data in the third row is 1, which is 5 minus 4. Additionally, the number of valid data in the fourth row is 1 by subtracting 5 from 6. If the number of valid data for each row is calculated through the previous process, the next step is to obtain column information of valid data for each row.

Specifically, valid data for each row can be obtained through each column information as well as csr_col, and specifically, the starting address of the column information of valid data present in the nth row can be obtained as csr_row [n].

To explain this with reference to the drawing, the column information of valid data of the 0th row of csr_col can be obtained from the address value of csr_row [0]=0, and the column information of valid data of the 1st row of csr_col can be obtained from the address value of csr_row [1]=1.

In addition, the column information of the valid data of the second row of csr_col can be obtained from the starting address 2, the column information of the valid data of the third row of csr_col can be obtained from the starting address 4, and the valid data of the fourth row of csr_col can be obtained from the starting address 5 (S20).

In other words, if the number of valid data present in each row is collected from each start address, column information of the valid data to be collected as much as the size of each kernel can be collected for the output row.

For example, when using the information of S10 and the information of S20, if column information of valid data of 0^{th} row is collected, one value is collected starting from the starting address 0, so the column information corresponding to I0 csr_col [0]=4 can be collected. In this way, when collecting the column information of the valid data of the first row, one value is collected starting from the starting address 1, so csr_col [1]=1, which is the column information corresponding to I1, can be collected.

The column information of the valid data in the second row collects two values starting from the starting address 2, so the column information corresponding to I2 and I3, csr_col [2]=2, csr_col [3]=3 can be collected.

Since the column information of the valid data in the third row collects one value starting from the starting address 4, csr_col [4]=3, which is the column information corresponding to I4, can be collected.

Since the column information of the valid data in the fourth row collects one value starting from the starting address 5, csr_col [5]=2, which is the column information corresponding to I5, can be collected (S30).

That is, the input data collection module collects valid data and invalid data including location information in the same manner as described in FIG. 12, and then sequentially stores the data by row.

To explain this by FIGS. 13 to 15, the sparse input data collection module 220 collects data based on the input index information 20, and the collected data is converted into output data output through a convolution operation considering the location of the row of the output data, and the sparse input data collection module 220 stores data sequentially for each corresponding row.

When storing the collected data, the input data collection module 220 may store the collected data in the collected data storage modules 221 to 223 provided corresponding to each row. Accordingly, the collection data storage modules 221 to 223 may be implemented with various types of registers capable of temporarily storing data.

Specifically, the input data collection module 220 may include a plurality of collection data storage modules 221 to 223 capable of storing collection data equal to the number of rows of the kernel. For example, the 0th row collection data storage module 221 can sequentially store the 0th row valid data collected based on the 0th row of the kernel 25, and the 1st row collection data storage module 222 can sequentially store the 1st row valid data collected based on the 1st row of the kernel, and the second row collection data storage module 223 may sequentially store the second row valid data collected based on the second row of the kernel.

Referring to FIG. 13, since zero padding is applied to the input data 10, there is no valid data corresponding to the 0th row of the kernel 25. Therefore, invalid data in which no data is stored, that is, invalid data of ‘x’, is stored in the 0th row collection data storage module 221.

Data related to the first row of the kernel 25 may be stored in the first-row collection data storage module 222. Since there is one valid data Io in the first row of the input data 10, valid data I0 may be stored in the first-row collection data storage module 212.

The second-row collection data storage module 223 may store data related to the second row of the kernel 25. Since there is only one valid data I1 in the first row of input data 10 corresponds to the second row of the kernel 25, the valid data I1 can be collected and stored in the second-row collection data storage module 223.

That is, if this is schematically displayed, invalid data or valid data can be collected and stored in each collection data storage module 221, 222, and 223, as shown on the right side of FIG. 13.

On the other hand, When the 3×3 kernel 25 performs a convolution operation while striding based on the 0th row of the input data 10, the data in rows 0 and 1 of the input data (there is zero padding so there is no row before row 0) is related to the data in row 0 of the output data.

When the kernel moves down one row and performs a convolution operation while star riding based on the first row, the data in the 0th, 1st, and 2nd rows of the input data become related to the data in the 1st row of the output data.

When the kernel moves down one row and performs a convolution operation while star riding based on the second row, the data in the first, second, and third rows of the input data becomes related with the second row of the output data.

Therefore, as indicated by the rectangular dotted box in FIG. 13, the data inside the rectangular dotted box are valid data related to the 0th output row of the output data, and due to the nature of the 3×3 convolution operation that also performs the operation on the upper and lower data, data within the oval dotted line in FIG. 4 become input data related to the first output row of output data.

Meanwhile, as seen above, when the stride of the kernel 25 based on the 0th row of the input data 10 is completed, the kernel 25 moves down one row and a convolution operation is performed based on the 1st row of the input data 10. Accordingly, the rows of input data that affect the results of the convolution operation are also moved down one row.

When explaining this based on FIG. 14, as shown on the left side of FIG. 14, the kernel 25 moves left and right while scanning and collecting data in the 0th, 1st, and 2nd rows of the input data 10.

Specifically, in the case of FIG. 14, valid data I0 in the 0th row of input data 10, valid data I1 in the 1st row, and valid data I2 and I3 in the 2nd row of the input data 10 may be collected. And the valid data collected in this way can be sequentially stored in the collected data storage module as described above.

However, when the kernel moves as shown in FIG. 14, the valid data in the 0th and 1st rows of the input data 10 are added to the already collected valid data when the kernel moves as shown in FIG. 13. Therefore, without the need to collect input data again, the valid data stored in each row collection data storage module can be moved according to the location of the row.

That is, as indicated by a solid black line in the right drawing of FIG. 14, 11, which is valid data stored in the second-row collection data storage module 223, is transmitted to the first-row collection data storage module 222 and stored at the first-row collection data storage module 222. And I0, which is the valid data stored in the 1st row collection data storage module 222, is transmitted to the 0th row collection data storage module 221 and stored in the 0th row collection data storage module 221.

However, when the kernel 25 starts striding based on the first row of the input data 10, the data in the second row of the input data 10 is additionally collected, so the additionally collected valid data I2 and I3 are sequentially input and stored in the second-row collection data storage module 223, as shown on the right side of FIG. 14.

In conclusion, when the kernel 25 completes stride based on the first row of the input data 10, I0, which is valid data related to the first output row of the output data, is stored in the 0th row collection data storage module 221. And valid data I1 associated with the first output row is stored in the first-row collection data storage module 222, and valid data I2 and I3 associated with the first output row are stored in the second-row collection data storage module 223.

This is expressed in a drawing, and as indicated by the rectangular dotted box in FIG. 14, the data inside the rectangular dotted box is valid data related to the first output row of the output data and due to the nature of the 3×3 convolution that also performs operations on the upper and lower data, the data within the oval dotted line in FIG. 14 becomes input data related to the second output row of the output data.

When the kernel according to FIG. 14 completes strides based on the 0th row of the input data 10, the kernel performs strides from left to right based on the 1st row of the input data 10 as shown on the left of FIG. 15. Accordingly, the rows of input data that affect the results of the convolution operation are also moved down one row.

If this is explained based on FIG. 15, as shown on the left side of FIG. 15, when the kernel 25 moves left and right and performs a convolution operation with the data in the first, second, and third rows of the input data 10, valid data I1 in the first row, valid data I2 and I3 in the second row, and valid data I4 in the third row are collected as valid data. And the collected valid data may be sequentially stored in the collected data storage modules 221, 222, and 223, respectively, as described above.

However, when the kernel moves as shown in FIG. 15, the valid data in the first and second rows of the input data 10 are added to the already collected valid data when the kernel moves as shown in FIG. 14. Therefore, without the need to collect input data again, the valid data stored in each row collection data storage module can be moved according to the location of the row.

That is, as indicated by the solid black line in the right drawing of FIG. 15, the valid data I3 and I2 stored in the second-row collection data storage module 223 are transmitted to the first row collection data storage module 222 and stored in the first row collection data storage module 222, and the valid data I1 stored in the first row collection data storage module 222 is transmitted to the zero row collection data storage module 221 and stored in the zero row collection data storage module 221.

However, when the kernel 25 starts striding based on the first row of the input data 10, the data in the third row of the input data 10 is additionally collected, so the additionally collected valid data I4 is sequentially input and stored in the second-row collection data storage module 223, as shown on the right side of FIG. 15.

In conclusion, when the kernel 25 completes stride based on the first row of the input data 10, I1, which is valid data related to the second output row of the output data, is stored in zero row the collection data storage module 221, valid data I2 and I3 related to the second output row are stored in the first row collection data storage module 222, and valid data I4 related to the second output row are stored in the second row collection data storage module 223.

That is, as indicated by the rectangular dotted box in FIG. 15, the data inside the rectangular dotted box are valid data related to the second output row of the output data, and the data inside the oval dotted line in FIG. 15 are the third output row of the output data.

When the collected valid data is sequentially divided and stored in each storage module as in the present invention, information about duplicate rows can be used as the information previously calculated, so even if the reference row of the kernel changes in the future, duplicate rows are stored and valid data can be reused. Therefore, when performing a convolution operation, the process of separately collecting input data again is omitted, thereby increasing the overall speed of the operation.

Hereinafter, we will look at the process of generating merged row information by the row information generation module 230 from the input data collected through FIGS. 12 to 15 through the drawings.

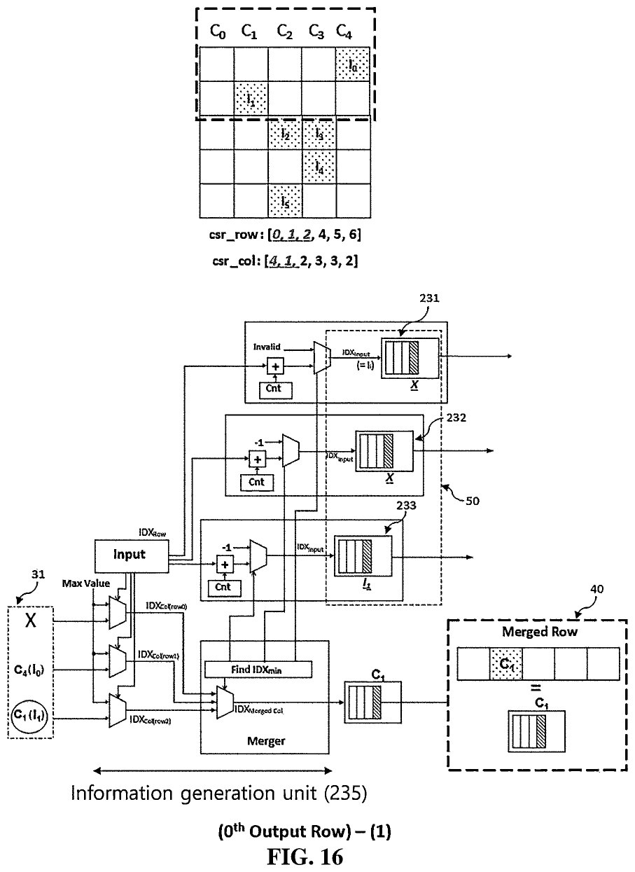

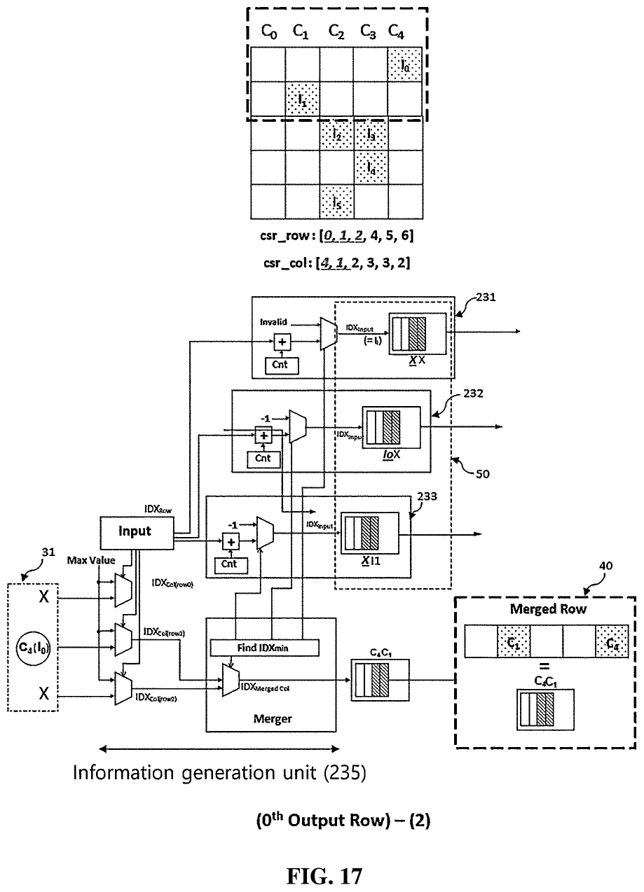

FIGS. 16 and 17 are diagrams to explain how a row information generation module according to another embodiment generates 0^{th} row extended row information corresponding to 0th row of output data.

The row information generation module 230 may generate extended row information, which is information about rows of output data corresponding to valid data collected by the sparse input data collection module 220.

The row information generation module 230 may include an information generation unit 235 that generates extended row information and an index storage module in which valid data and invalid data are stored. The index storage module may be provided as many times as the number of rows in the kernel. That is, in the case of the present invention, it is explained based on a 3×3 kernel, and the index storage module may include a 0th index storage module 231, a 1st index storage module 232, and a 2nd index storage module 233.

The information generation unit 235 generates extended row information that reflects the vertical dilation effect that occurs due to the nature of the convolution operation on the valid and invalid data collected by row by the input data collection module 220.

Specifically, the information generation unit 235 receive the data stored first in the 0th row collection data storage module 221, the 1st row collection data storage module 222, and the 2nd row collection data storage module 223 as the first input information 31. After receiving the first input information 31 (see FIG. 4), the information generation unit 235 determines the input data corresponding to the smallest column in the first input information 31 and generates expanded row information based on this.

The extended row information referred to here refers to information containing index information about a column that performs a convolution operation based on a specific row (In other words, it can be understood as information that considers the vertical blurring effect that occurs due to the nature of the convolution operation).

If explained based on FIG. 16, the input data in the smallest column in the first input information 31 is I1 in the first column (hereinafter, this corresponding configuration is expressed as C1 (I1)), so the 0th row expanded row information 40, index information C1 is generated in the first column as shown in the figure.

And at the same time, index information for data corresponding to C1 must also be stored. Since C1 is in the 3rd row of the first input information 31, it performs a convolution operation with the 2nd row of the kernel 25. Therefore, as shown in FIG. 16, I1, which is index information of valid data corresponding to C1, is stored in the second-row index storage module 233.

Meanwhile, since only the blurring effect corresponding to C1 is considered in this step, ‘x’ is stored as an invalid value in the 0th row index storage module 231 and the 1st row index storage module 232.

When the first minimum comparison in the first input information 31 is completed, the information generation unit 235 performs the minimum comparison process between the remaining information in the first input information 31 again.

That is, because the input data in the second row of the first input information 31 is stored in the second row index storage module 233 through the first comparison process, Only the C4 (I0) data in the first row remains as valid data among the first input information 31, and the C4 (I0) data in the first row is also selected as the smallest column as shown in FIG. 17.

Accordingly, in the 0th extended row information 40, index information C4 is additionally generated in the fourth column as shown in the figure, and at the same time, data corresponding to C4 is also stored in the index storage module.

Specifically, since C4 is in the second row in the first input information 31, this means that a convolution operation is performed with the first column of the kernel 25. Therefore, as shown in FIG. 17, I0, which is index information of valid data corresponding to C4, is stored in the first-row index storage module 232, and ‘x’ is stored as an invalid value in the 0th row index storage module 231 and the second-row index storage module 233.

When the 0th row extended row information 40 for the 0th row is generated through FIGS. 16 and 17, the information generation unit 235 generates the 1st row extended row information 41 for the 1st row.

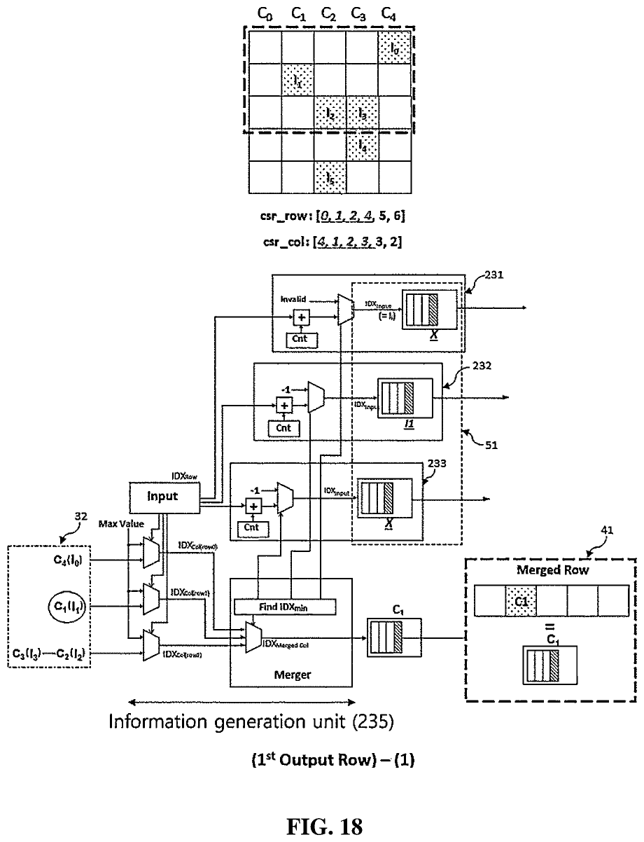

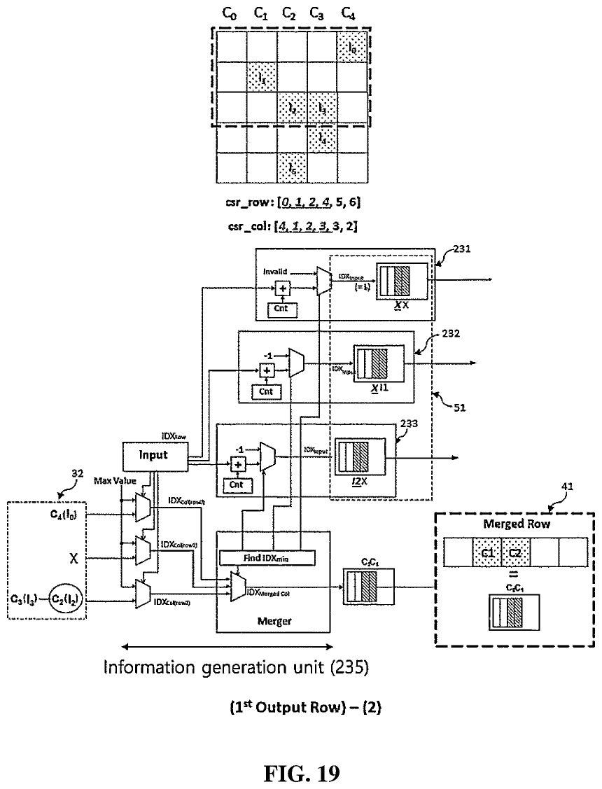

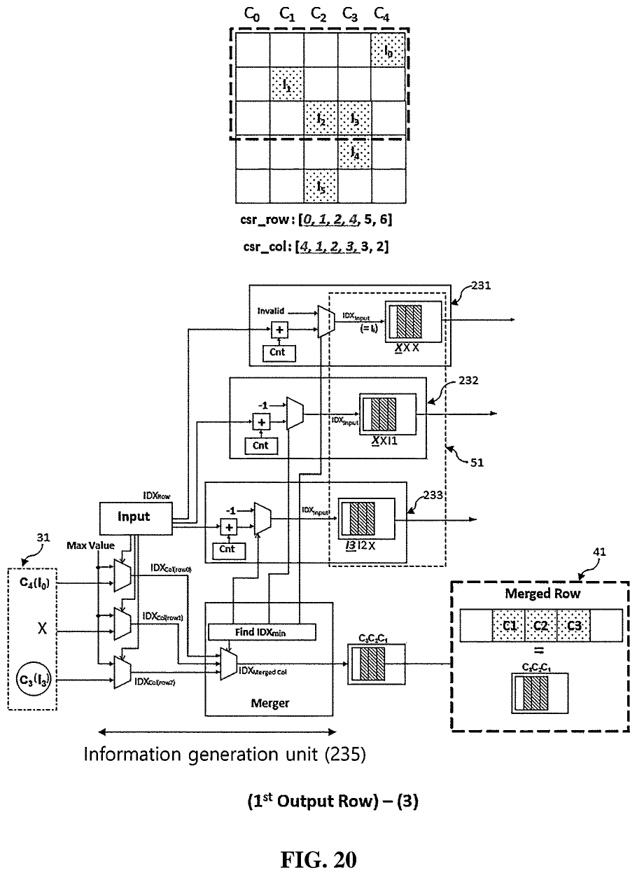

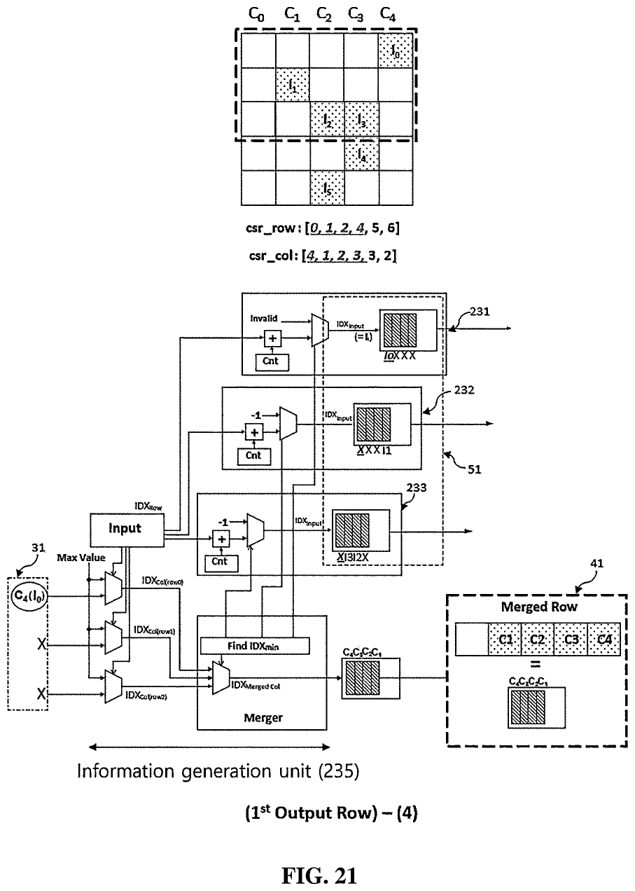

FIGS. 18 to 21 are diagrams for explaining a method in which a row information generation module generates first row extended row information corresponding to the first row of output data according to another embodiment.

Referring to FIGS. 18 to 21, the second data stored in the 0th row collection data storage module 221, the first-row collection data storage module 222 and the second row collection data storage module 223 becomes the second input information 32 input to the information generation unit 235 in response to the first row extended row information 41 (see FIG. 6).

When the second input information 32 is input to the information generation unit 235, the input data in the smallest column of the second input information 32 is sequentially searched, and since the data placed in the smallest column of the second input information is I1 stored in the first row, C1, which is index information, is generated in the first column in the first row extended row information 41 as shown in the drawing.

At the same time, information about the data corresponding to C1 is also stored in the index storage module. Since C1 is in the first row of the input data, this means that a convolution operation is performed with the second row of the kernel 25. Therefore, as shown in FIG. 18, I1, which is index information of valid data corresponding to C1, is stored in the first-row index storage module 232, and ‘x’ is stored as an invalid value in the 0th row index storage module 231 and the second-row index storage module 231.

When the first minimum comparison is completed in the second input information 32, the information generation unit 235 performs the minimum comparison process again on the remaining information in the second input information 32.

That is, because the data in the first row in the second input information 32 is stored in the first-row index storage module 232 through the first comparison process, in the second input information 32, as shown in FIG. 19, the only valid data remaining is the data in 0^{th} row and 2^{nd} row. And here, the data located in the smallest column among the input data 10 is the C2 (I2) data located in the second column of the input data 10.

Accordingly, index information C2 is additionally generated in the second column as shown in the figure in the first-row extended row information 41, and at the same time, data corresponding to C2 is also stored in the index storage module.

Specifically, since C2 is in the 3rd row of the second input information 32, this means that a convolution operation is performed with the 2nd column of the kernel 25. Therefore, as shown in FIG. 19, 12, which is index information of valid data corresponding to C3, is stored in the second-row index storage module 233, and ‘x’ is stored as an invalid value in the first-row index storage module 232 and the 0th row index storage module 233.

When the second minimum comparison in the second input information 32 is completed, the information generation unit 235 performs the minimum comparison process on the remaining information in the second input information 32 again.

That is, because the first data in the first and second rows in the second input information 32 were stored in the index storage module through the first and second comparison processes, respectively, the only valid data remaining among the second input information 32 is the data in 0th row and 2nd row as shown in FIG. 20. And among these data, the data located in the smallest column in the input data becomes C3 (I3) data in the third column.

Accordingly, in the first-row extended row information 41, index information C3 is additionally created in the third column as shown in FIG. 20, and at the same time, data corresponding to C3 is also stored in the index storage module.

Specifically, since C3 is in the 3rd row of the input data, this means that a convolution operation is performed with the 2nd row of the kernel 25. Therefore, as shown in FIG. 20, 13, which is index information of valid data corresponding to C3, is sequentially stored after ‘I2’ in the second-row index storage module 233, and ‘x’ is stored as an invalid value in the 0th row index storage module 231 and the first-row index storage module 232.

When the third minimum comparison in the second input information 32 is completed, the information generation unit 235 performs the minimum comparison process on the remaining information in the second input information 32 again.

That is, because the data in the first and second rows of the second input information 32 were stored in the index storage module through the first, second, and third comparison processes, respectively, as shown in FIG. 21, the only valid data remaining among the second input information 32 is the data in 0th row. Accordingly, the C4 (I0) data in the fourth column is selected from the input data 10.

Accordingly, in the first-row extended row information 41, index information C4 is additionally generated in the fourth column as shown in the figure, and at the same time, data corresponding to C4 is also stored in the index storage module.

Specifically, since C4 is in the 1st row of the input data, this means that a convolution operation is performed with the 0th row of the kernel 25. Therefore, as shown in FIG. 21, I0, which is index information of valid data corresponding to C4, is stored in the 0th row index storage module 231, and ‘x’ is stored as an invalid value in the 1st row index storage module 232 and the 2nd row index storage module 233.

Referring to FIGS. 18 to 21, when the first-row extension row information 41 for the first row of output data is generated, the information generation unit 235 generates the second-row extension row information 42 for the second row of output data.

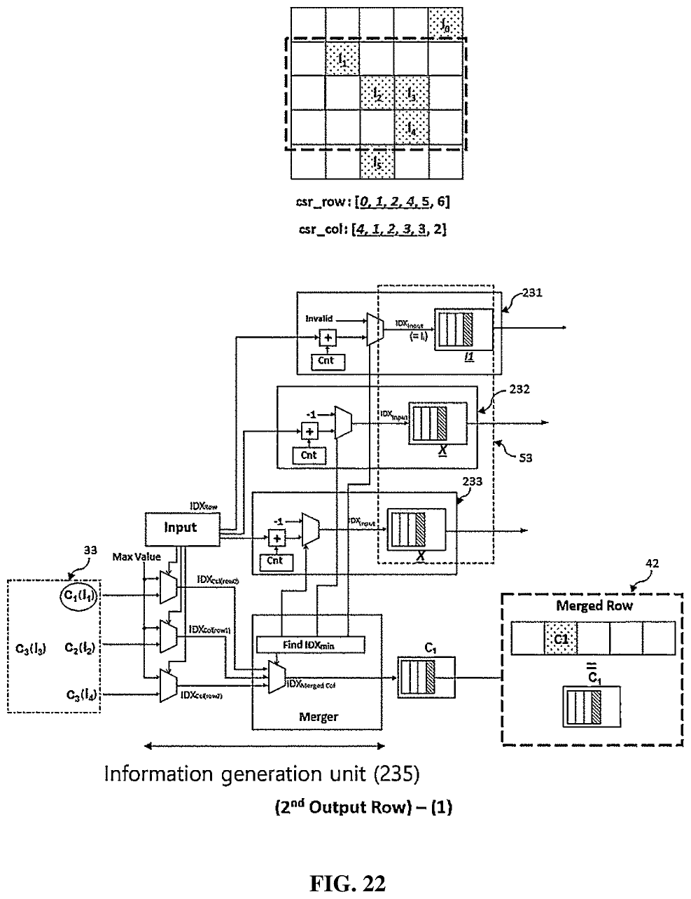

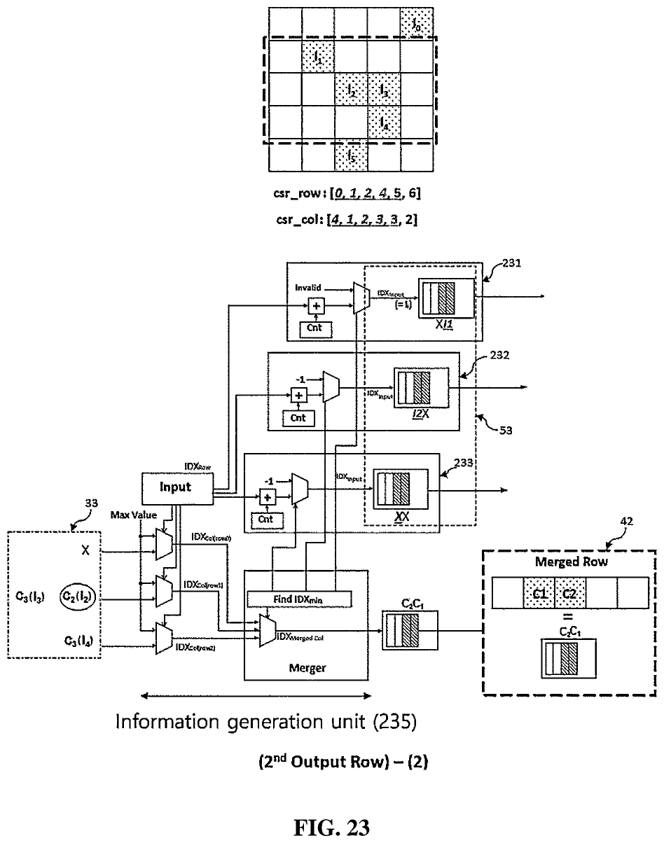

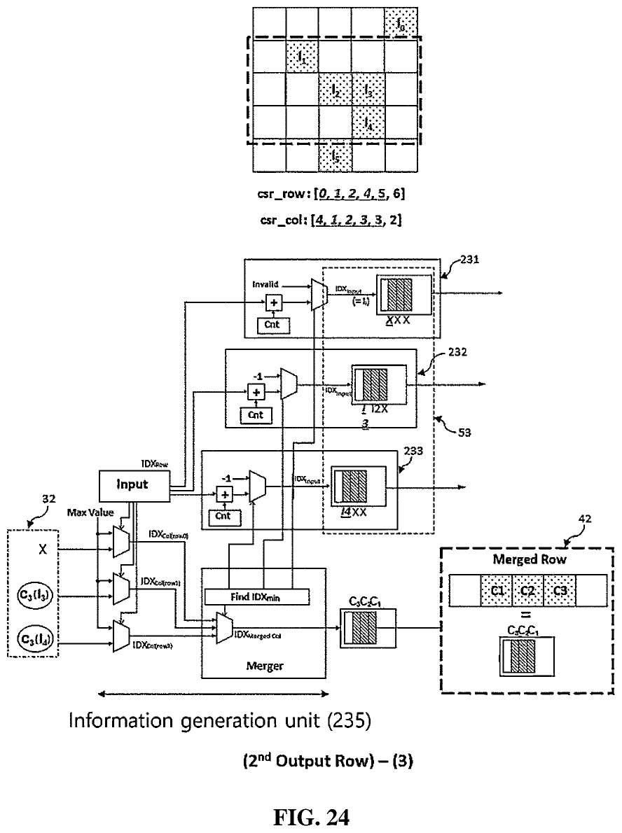

FIGS. 22 to 24 are diagrams for explaining how a row information generation module according to another embodiment generates second row extended row information corresponding to the second row of output data. The principle of generating the second-row extended row information 42 is the same as the principle of generating the zero row extended row information 40 and the first row extended row information 41 described above, and a detailed description of the principle will be omitted. Illustrations should be used instead of explanations.

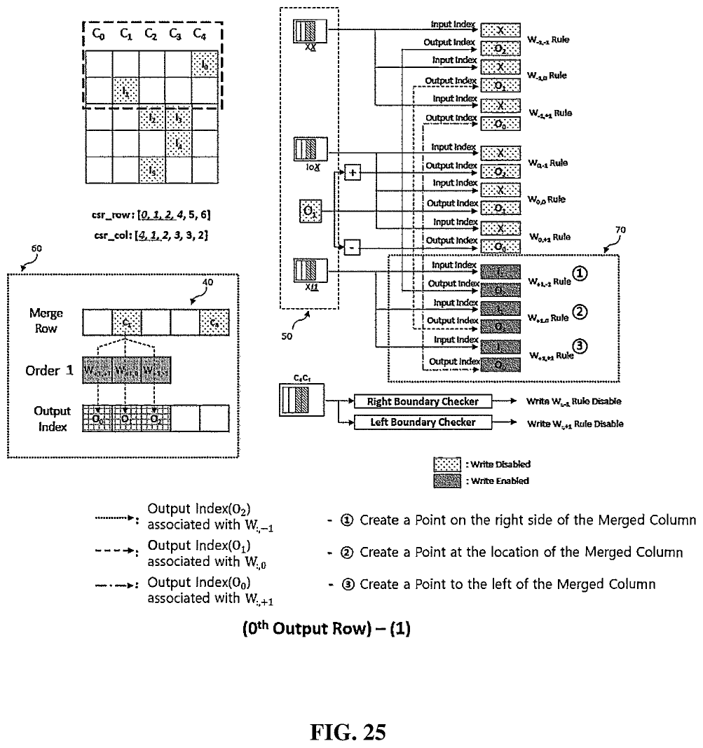

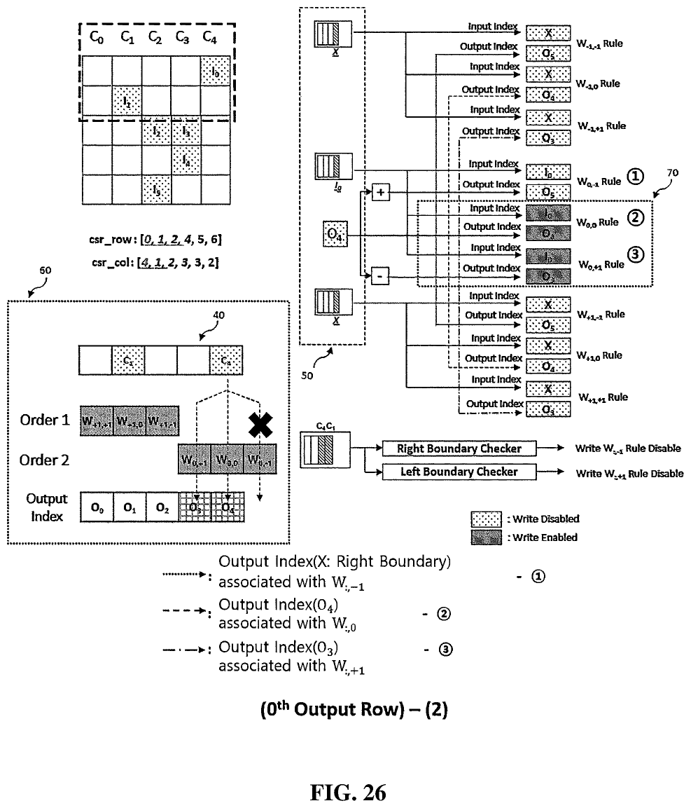

FIGS. 25 and 26 are diagrams to explain how the convolution operation module according to the present invention generates rules necessary for convolution operation. FIGS. 25 and 26 is a diagram showing how the convolution operation module to create an index rule related to the output information of 0th row of for each input index.

The convolution operation module 240 is a module that generates the index information required to perform the convolution operation as rule information (information about which valid data of the input data and which columns and rows of the kernel perform the convolution operation to produce the result in which rows and columns of the output data) based on the merge row information generated by the row information generation module 230 for the input data 10, the input index information 42 sequentially generated and stored for each column, and the kernel size information.

As shown in the figure, when striding is performed based on the 0th row of the input data 10 of the kernel 25, as seen in FIGS. 16 and 17, since the input index is generated by dividing a total of two sets (X, X, I1/X, I0, X), the 0th row of output data is the output data that has been calculated with the above two input indices. FIG. 25 is a diagram explaining the process of creating a rule for performing a convolution operation based on the first input index (X, X, I1). FIG. 26 is a diagram explaining the process of generating a rule for performing a convolution operation based on the second input index (X, I0, X).

Referring to FIG. 25, explaining the operation rule generated for the 0th input index (X, X, I1), when the kernel 25 strides based on the 0th row for the input data 10, the column on which the convolution operation is performed first corresponds to C1, the first column in which data is located on the leftmost side of the 0th row extended row information 40.

Therefore, the reference output index of the output data output when the 0th input index (X, X, I1) the 3×3 kernel performs a convolution operation is O1 corresponded with C1. Therefore, when the 3×3 kernel performs a convolution operation with C1, due to the characteristics of the 3×3 kernel, the output index is expanded one by one on the left and right based on the reference output index O1, to become O2, O1, and O0. That is, the result of the 0th input index (X, X, I1) and the kernel operation are output to O2, O1, and O0.

To express this schematically, as shown in FIG. 25, the output index is expanded to O2, O1, and O0 due to the reference output index O1, and in the case of a 3×3 kernel, there are a total of 9 kernel indexes (W_{-1,-1}/W_{-1,0}/W_{-1,1}/W_{0,-1}/W_{0,0}/W_{0,1}/W_{1,-1}/W_{1,0}/W_{1,1}), so the output index associated with W_{-1,-1}, W_{0,-1}, W_{1,-1} becomes O2, and the output index associated with W_{-1,0}, W_{0,0}, W_{1,0} becomes O1, and The output index associated with W_{-1,1}, W_{0,1}, W_{1,1} becomes O0.

In other words, the output index generated by C1 is O0˜O2, so O2 is generated as a pair of the input index corresponding to C1 and the kernel index information associated with W_{X,-1} (X is one of −1, 0, and 1), O1 is generated as a pair of the input index corresponding to C1 and kernel index information associated with W_{X,0} and O0 is created as a pair of the input index corresponding to C1 and kernel index information associated with W_{X,1}.

And, since the 0th input index corresponding to C1 is (X, X, I1), the input index corresponding to the 0th row is becoming X, the input index corresponding to the 1st row is becoming X, and the input index corresponding to the 2nd row is becoming I1. Therefore, the input index X corresponding to 0^{th} row is sequentially input to the input index associated with kernel W_{-1,-1}, W_{-1,0} W_{-1,1}, the input index X corresponding to 1^{st} row input to the input index associated with kernel W_{0,-1} W_{0,0}, W_{0,1} and, the input index I1 corresponding to the second row is sequentially input to the input index associated with kernel W_{1,-1}, W_{1,0}, W_{1,1}.

However, since the input index X means data with no data, there is no need to calculation. Therefore, no calculation is performed on kernels W_{-1,-1}, W_{-1,0}, W_{-1,1} and kernels W_{0,-1} W_{0,0}, W_{0,1}, so there is no need to generate rule information, the indexes of the kernel where the actual calculation is performed are W_{1,-1}, W_{1,0} W_{1,1}.

Therefore, the 0th input index (X, X, I1) and the index where the kernel performs the convolution operation correspond only to the part indicated by the index box 70 in the drawing. And it may be displayed as an operation box 60 shown on the left side of the drawing. Once rule information for the 0th input index is created in this way, rule information for the 1st input index is created in the next step.

Referring to FIG. 26, explaining the operation rules generated for the first input index (X, I0, X), since the 0th input index (X, X, I1) has been calculated in the input index, only the last remaining 1st input index (X, I0, X) is operated with the kernel based on O4, the reference output index.

When the kernel 25 strides based on the 0th row in the input data 10, the column on which the second convolution operation is performed is C4, the 4th column corresponding to the second smallest column in the 0th extended row information 40. Therefore, the reference index at which the output data is output by performing a convolution operation between the first input index (X, I0, X) becomes O4 corresponding C4, due to the characteristics of the 3×3 kernel, the output index is expanded one by one on the left and right based on O4 to become O5, O4, and O3.

To express this schematically, as shown in FIG. 26, when the reference output index is O4, the output index is expanded to O5, O4, and O3, and in the case of a 3×3 kernel, there are a total of 9 kernel (W_{-1,-1}/W_{-1,0}/W_{-1,1}/W_{0,-1}/W_{0,0}/W_{0,1}/W_{1,-1}/W_{1,0}/W_{1,1}), the output index associated with W_{-1,-1}, W_{0,-1}, W_{1,-1} becomes O5, the output index associated with W_{-1,0}, W_{0,0}, W_{1,0} becomes O4, and the output index associated with W_{-1,1}, W_{0,1}, W_{1,1} becomes O3.

However, since O5, which is expanded to a row based on O4, is an index that does not exist, in conclusion, the first input index (X, I0, X) and the result of the kernel operation are output only to O3 and O4.

In other words, the output index generated by C4 is O3˜O4, so O4 is created in pairs with the input index corresponding to C4 and the kernel index information associated with W_{X,0} and O3 is created in pairs with the input index corresponding to C4 and the kernel index information associated with W_{X,1}.

And, since the first input index corresponding to C4 is (X, I0, X), the input index corresponding to the 0th row becomes X, the input index corresponding to the 1st row becomes I0, and the input index corresponding to the 2nd row becomes X.

Therefore, the input index X corresponding to 0th row is sequentially entered into the input index associated with kernel W_{-1,-1}, W_{-1,0} W_{-1,1}, the input index I0 corresponding to 1^{st} row is sequentially entered into the input index associated with kernel W_{0,-1} W_{0,0}, W_{0,1}, and the input index X corresponding to 2nd row is sequentially entered into the input index associated with kernel W_{1,-1}, W_{1,0}, W_{1,1}.

However, since the input index means data with no data, there is no need to calculation. Therefore, no calculation is performed on kernels W_{-1,-1}, W_{-1,0} W_{-1,1} and W_{1,-1}, W_{1,0}, W_{1,1}, so there is no need to generate rule information. The kernel indices where the calculation is actually performed are W_{0,-1} W_{0,0} W_{0,1}. As seen earlier, O5 is an output index that does not exist, so there is no need to perform the calculation on O5.

Therefore, the first input index (X, I0, X) and the index where the kernel performs the convolution operation correspond only to the part indicated by the index box 70 in the drawing. And it may be displayed as an operation box 60 shown on the left side of the drawing. Through this method, the creation of rules related to the output information of row 0 of the output data is completed.

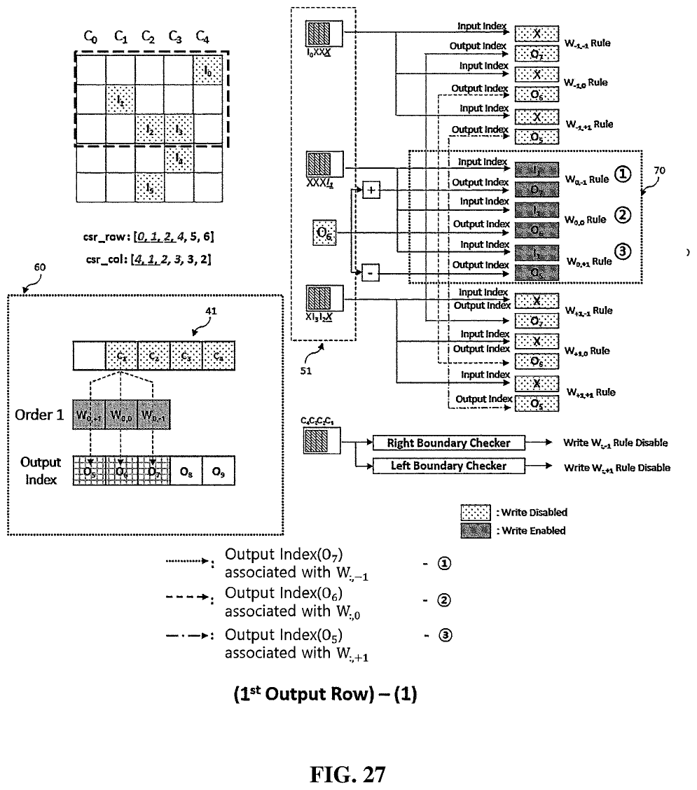

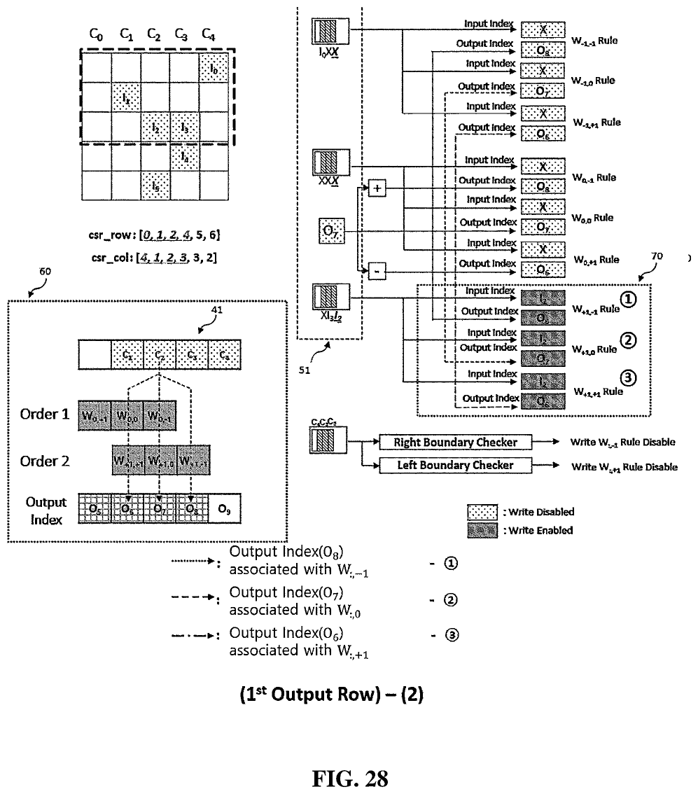

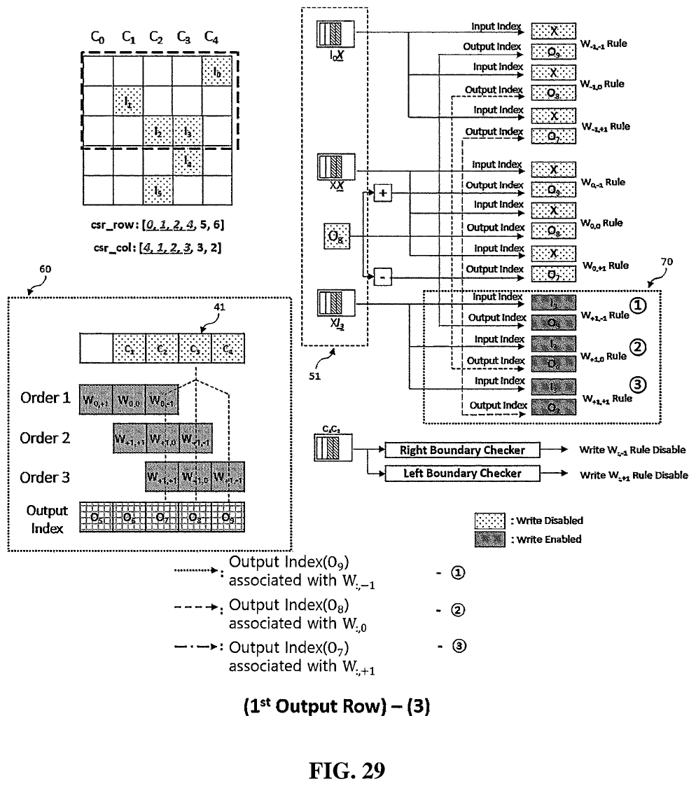

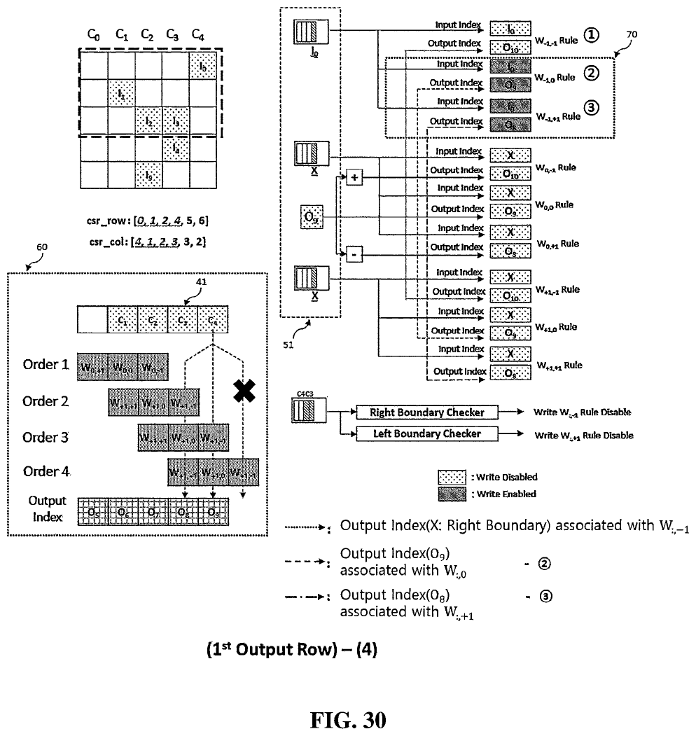

FIGS. 27 to 30 are diagrams showing a method of generating an index rule related to output information of the first row of output data for each input index.

Referring to FIG. 27, explaining the operation rule generated for the 0th input index (X, I1, X) associated with the 1st row of output data, when the kernel 25 performs star riding on the input data 10 based on the first row, the column on which the kernel 25 performs the operation first is C1 the leftmost column in the first extended row information 41.

Therefore, the reference index of the output data, where the output data is output by performing a convolution operation between the 0th input index (X, I1, X) and kernel, is O6 corresponding to C1. Therefore, when the 3×3 kernel performs a convolution operation with C1, due to the characteristics of the 3×3 kernel, the output indices are expanded one by one on the left and right based on the reference output index, O6, to become O7, O6, and O5. That is, the operation result of between the kernel and the first input index (X, I1, X) output to O7, O6, and O5.

To express this graphically, as shown in FIG. 27, when the central output index is input as O6, the output index become O7, O6, and O5, and in the case of a 3×3 kernel, there are a total of 9 kernel indices (W_{-1,-1}/W_{-1,O}/W_{-1,1}/W_{0,-1}/W_{0,0}/W_{0,1}/W_{1,-1}/W_{1,O}/W_{1,1}), so the output index associated with W_{-1,-1}, W_{0,-1}, W_{1,-1} becomes O7, the output index associated with W_{-1,O}, W_{0,0}, W_{1,O} becomes O6, and the output index associated with W_{-1,1}, W_{0,1}, W_{1,1} becomes O5.

In other words, the output indices generated based on C1 are O5˜O7, so O7 is created as a pair of the input index corresponding to C1 and the kernel index information associated with W_{X,-1} (X is one of −1, 0, and 1), O6 is created as a pair of the input index corresponding to C1 and kernel index information associated with W_{X,0}, and O5 is created as a pair of the input index corresponding to C1 and kernel index information associated with W_{X,1}.

And, since the 0th input index corresponding to C1 is (X, I1, X), the input index corresponding to the 0th row is X, the input index corresponding to the 1st row is I1, and the input index corresponding to the 2nd row becomes X.

Therefore, the input index X corresponding to 0th row is sequentially entered into the input index associated with kernel W_{-1,-1}, W_{-1,0} W_{-1,1}, the input index X corresponding to 1st row is sequentially entered into the input index associated with kernel W_{0,-1} W_{0,0}, W_{0,1}, and the input index X corresponding to 2nd row is sequentially entered into the input index associated with kernel W_{1,-1}, W_{1,0}, W_{1,1}.

However, since the input index means data with no data, there is no need to calculation. Therefore, no calculation is performed on kernels W_{-1,-1}, W_{-1,0} W_{-1,1} and kernels W_{1,-1}, W_{1,0}, W_{1,1}, so there is no need to generate rule information. So, the indexes of the kernel where the actual calculation is performed are W_{0,-1} W_{0,0}, W_{0,1}.

Therefore, the 0th input index (X, I1, X) and the index where the kernel performs the convolution operation correspond only to the part indicated by the index box 70 in the drawing. And it may be displayed as an operation box 60 shown on the left side of the drawing.

Since the 0th input index (X, I1, X) has been calculated in the input index, the next input index, the 1st input index (X, X, I2), is operated with the kernel based on the reference output index O7.

When the kernel 25 strides on the input data 10 based on the first row, the column on which the convolution operation is performed second is C2, which is the second smallest column in the first-row expansion row information 41. Accordingly, the first input index (X, X, I2) and the kernel perform a convolution operation and the reference output index at which the output data is output is O7 corresponding to C2. Therefore, when the 3×3 kernel performs a convolution operation with C2, due to the characteristics of the 3×3 kernel, the output index expands one on the left and right based on O7 to become O8, O7, and O6.

In other words, the output index generated by C2 are O6˜O8, so O8 is created as a pair of the input index corresponding to C2 and the kernel index information associated with W_{X,-1}, and O7 is created in pairs with the input index corresponding to C2 and the kernel index information associated with W_{X,0}, and for O6, the input index corresponding to C2 and the kernel index information associated with W_{X,1} are created in pairs.

And, since the second input index corresponding to C2 is (X, X, I2), the input index corresponding to the 0th row becomes X, the input index corresponding to the 1st row becomes X, and the input index corresponding to the 2nd row becomes I2.

Therefore, input index X corresponding to the 0th row is sequentially input to the input index associated with kernel W_{-1,-1}, W_{-1,0} W_{-1,1}, input index X corresponding to the 1st row is sequentially input to the input index associated with kernel W_{0,-1} W_{0,0}, W_{0,1} and input index I2 corresponding to the 2nd row is sequentially input to the input index associated with kernel W_{1,-1}, W_{1,0}, W_{1,1}.

However, since the input index means data with no data, as seen earlier, the calculation itself is not performed, so the kernel indexes where the calculation is actually performed are W_{1,-1}, W_{1,0}, W_{1,1}. Therefore, the 2nd input index (X, X, I2) and the index where the kernel performs the convolution operation correspond only to the part indicated by the index box 70 in the drawing. And it may be displayed as an operation box 60 shown on the left side of the drawing.

Once rule information for the first input index is created in this way, rule information for the second input index is created in the next step.

Referring to FIG. 29, explaining the operation rule generated for the second input index (X,X,I3), since the 0th input index (X,I1,X) and 1st input index (X, X, I2) has been calculated in the input index, only the next 2nd input index (X,X,I3) is operated with the kernel based on O8, the reference output index.

When the kernel 25 strides based on the second row for the input data 10, the third column on which the convolution operation is performed is C3, the third smallest column in the second extended row information 42. Accordingly, the reference output index at which output data is output by performing a convolution operation between the second input index (X, X, I3) becomes O8 corresponding to C3. Therefore, when the 3×3 kernel performs a convolution operation with C3, due to the characteristics of the 3×3 kernel, the output index is expanded one by one on the left and right based on O8 to become O9, O8, and O7.

In other words, the output indexes generated corresponding to C3 are O7˜O9, so O9 is created as a pair of the input index corresponding to C3 and the kernel index information associated with W_{X,-1}, and O8 is the input index corresponding to C3 and the kernel index information associated with W_{X,0} is created in pairs, and for O7, the input index corresponding to C3 and kernel index information associated with W_{X,1} are created in pairs.

And, since the second input index corresponding to C3 is (X, X, I3), the input index corresponding to the 0th row becomes X, the input index corresponding to the 1st row becomes X, and the input index corresponding to the 2nd row becomes I3. Therefore, the input index X in 0th row is sequentially input to the input index associated with W_{-1,-1}, W_{-1,0} W_{-1,1}, the input index X in 1st row is sequentially input to the input index associated with W_{0,-1} W_{0,0}, W_{0,1}, and input index I3 corresponding to the second row is input to the input index associated with kernel W_{1,-1}, W_{1,0}, W_{1,1}.

However, since the input index X means no data, there is no need to calculation. So, the indexes of the kernel where the actual calculation is performed are kernel W_{1,-1}, W_{1,0}, W_{1,1}.

Therefore, the 2nd input index (X, X, I3) and the index where the kernel performs the convolution operation correspond only to the part indicated by the index box 70 in the drawing. And it may be displayed as an operation box 60 shown on the left side of the drawing.

Once rule information for the second input index is created in this way, rule information for the third input index is created in the next step.

Referring to FIG. 30, explaining the operation rule generated for the third input index (10, X, X), since the 0th input index (X,I1,X), 1st input index (X, X, I2) and 2nd input index (X, X, I3) has been calculated in the input index, only the next 3rd input index (I0, X, X) is operated with the kernel based on O9, the reference output index.

When the kernel 25 strides on the input data 10 based on the first row, the fourth column on which the convolution operation is performed is C4, the fourth smallest column in the second extended row information 42.

Therefore, the reference output index, where the third input index (I0, X, X) and kernel performs a convolution operation and the output data is output, becomes O9 corresponding to C4. Therefore, when the 3×3 kernel performs a convolution operation with C4, due to the characteristics of the 3×3 kernel, the output index is expanded one by one on the left and right based on O9 to become O10, O9, and O8.

In other words, the output indexes generated corresponding to C4 are O8 to O10, so O10 is created as a pair of the input index corresponding to C4 and kernel index information related to W_{X,-1}, and O9 is the input index corresponding to C4 and kernel index information associated with W_{X,0} is created as a pair, and for O8, the input index corresponding to C4 and kernel index information associated with W_{X,1} are created as a pair.

And the third input index corresponding to C4 is (I0, X, X), so the input index corresponding to the 0th row becomes I0, the input index corresponding to the 1st row becomes X and the input index corresponding to the 2nd row becomes X. Therefore, the input index I0 corresponding to the 0th row is sequentially input to the input indexes associated with the kernels W_{-1,-1}, W_{-1,0}, W_{-1,1}, and the input index X corresponding to the 1st row is sequentially input to the input indices associated with kernel W_{0,-1} W_{0,0}, W_{0,1}, and the input index X corresponding to the second row is the input index associated with kernels W_{1,-1}, W_{1,0}, W_{1,1}.

However, since the input index means no data, as seen earlier, the calculation itself is not performed, so the kernel indices where the calculation is performed are W_{-1,0}, W_{-1,1}, due to the nature of the 3×3 kernel, there is no O10 matrix leading from O9 to the row, so no calculation is performed on the output index O10.

Therefore, the 3rd input index (I0, X, X) and the index where the kernel performs the convolution operation correspond only to the part indicated by the index box 70 in the drawing. And it may be displayed as an operation box 60 shown on the left side of the drawing.

As FIGS. 27 to 30, when an operation rule for the first row of output data is generated, the convolution operation module 240 generates an operation rule for the second row and the third row of the output data. Then, the convolution operation is performed according to the generated rules.

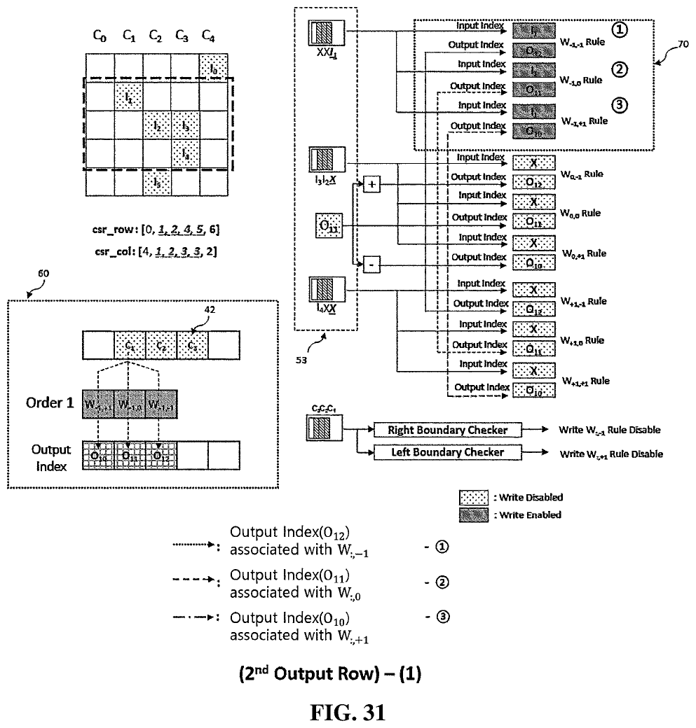

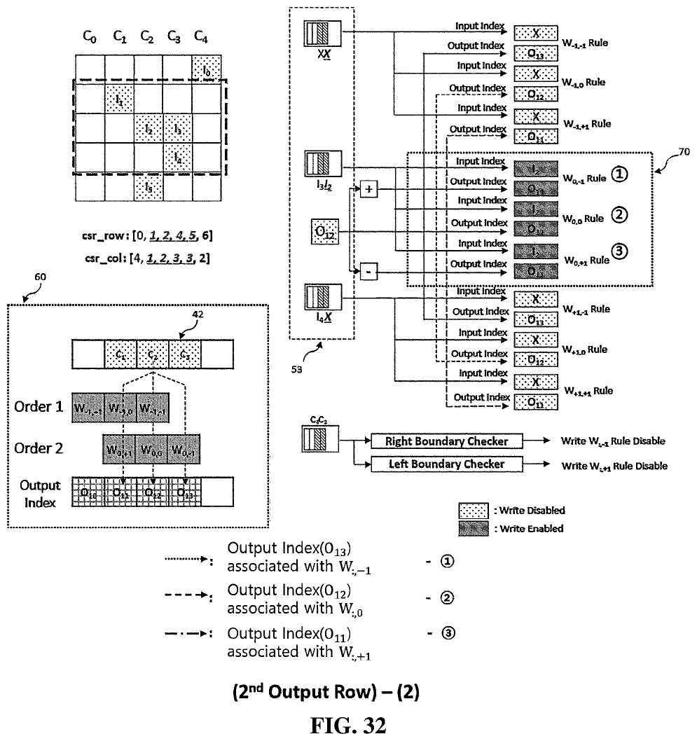

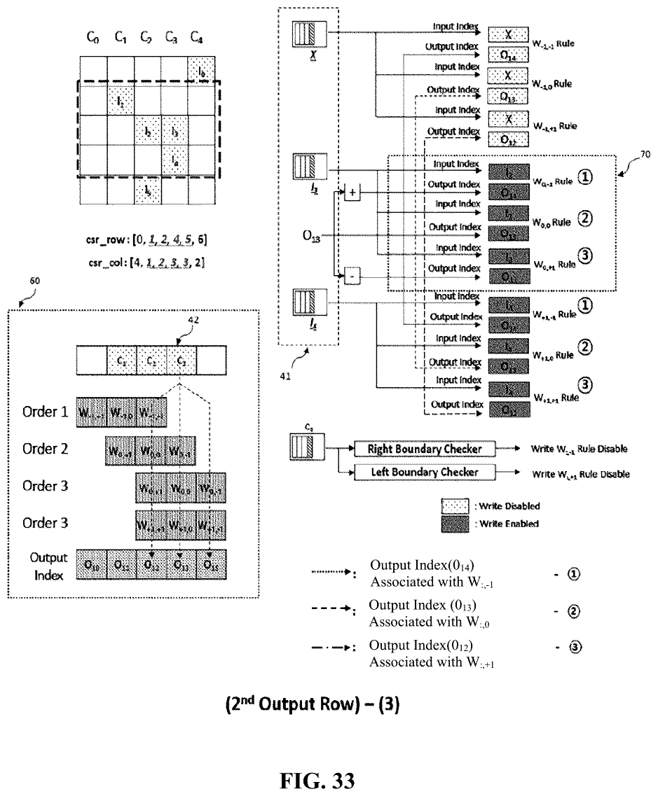

FIGS. 31 to 33 are diagrams for explaining a process in which a convolution operation module generates an operation rule for the second row of output data according to another embodiment of the present invention.

The principle by which the convolution operation module 240 according to the present invention generates the operation rule for the second row is the same as the principle of generating the operation rule for the 0th row and the operation rule for the 1st row described above. The description shall be omitted, and the description shall be replaced with drawings.

So far, we have looked at the configuration and process of the present invention in detail through the drawings.

In performing a convolution operation based on sparse data using an artificial neural network according to another embodiment, a convolution operation method and device based on sparse data is used to calculate input data according to rules generated by considering the location of input data and the location of output data. Since the convolution operation is performed only on valid data among the data, unnecessary operations can be reduced, and the convolution operation can be performed faster than the prior art.

Additionally, these features can increase the speed of object recognition in three-dimensional space, enabling efficient high-speed front obstacle recognition essential for high-dimensional autonomous driving, and RGB-D-based robot navigation for fast and accurate robot navigation. There is an advantage in that location estimation can also be performed efficiently.

The device described above may be implemented with hardware components, software components, and/or a combination of hardware components and software components. For example, devices and components described in embodiments may include, for example, a processor, a controller, an arithmetic logic unit (ALU), a digital signal processor, a microcomputer, a field programmable array (FPA), it may be implemented using one or more general-purpose or special-purpose computers, such as a programmable logic unit (PLU), microprocessor, or any other device capable of executing and responding to instructions. A processing device may perform an operating system (OS) and one or more software applications that run on the operating system. Additionally, a processing device may access, store, manipulate, process, and generate data in response to the execution of software. For ease of understanding, a single processing device may be used; however, those skilled in the art will understand that a processing device includes multiple processing elements and/or multiple types of processing elements. For example, a processing device may include multiple processors or one processor and one controller. Additionally, other processing configurations, such as parallel processors, are possible.

Software may include a computer program, code, instructions, or a combination of one or more of these, which may configure a processing unit to operate as desired or may be processed independently or collectively. You can command the device. Software and/or data may be used on any type of machine, component, physical device, virtual equipment, computer storage medium or device to be interpreted by or to provide instructions or data to a processing device. Software may be distributed over networked computer systems and stored or executed in a distributed manner. Software and data may be stored on one or more computer-readable recording media.

The method according to the embodiment may be implemented in the form of program instructions that can be executed through various computer means and recorded on a computer-readable medium. The computer-readable medium may include program instructions, data files, data structures, etc., singly or in combination. Program instructions recorded on the medium may be specially designed and configured for the embodiment or may be known and available to those skilled in the art of computer software. Examples of computer-readable recording media include magnetic media such as hard disks, floppy disks, and magnetic tapes, optical media such as CD-ROMs and DVDs, and magnetic media such as floptical disks.—Includes optical media (magneto-optical media) and hardware devices specifically configured to store and execute program instructions, such as ROM, RAM, flash memory, etc. Examples of program instructions include machine language code, such as that produced by a compiler, as well as high-level language code that can be executed by a computer using an interpreter, etc.

As described above, although the embodiments have been described with limited examples and drawings, various modifications and variations can be made by those skilled in the art from the above description. For example, the described techniques are performed in a different order than the described method, and/or components of the described system, structure, device, circuit, etc. are combined or combined in a different form than the described method, or other components are used. Alternatively, appropriate results may be achieved even if substituted or substituted by an equivalent. Therefore, other implementations, other embodiments, and equivalents of the claims also fall within the scope of the claims described below.

1. A method of convolution operation based sparse data using artificial neural network that performs convolution operations using processor and memory comprising:
an index information extraction step of extracting index information, which is location information about a valid data where actual data exists in an input data;
a first location information generation step of generating a first location information including a computable row information in which actual operations are performed in the kernel based on a path along which a kernel moves to perform a convolution operation on the input data and the index information;
a second location information generation step of generating second location information including a computable column information in which an actual operation is performed in the kernel based on the first location information, the index information, and the size of the kernel;
an operation rule generation step of generation an operation rule for each point of the valid data and convolution output data based on the index information, the first location information, and the second location information; and
a convolution operation step of performing a convolution operation based on the operation rule.

2. The method of convolution calculation based sparse data using artificial neural network according to claim 1,
wherein the first location information generation step includes a step of sequentially generating the first location information for each row of the input data.

3. The method of convolution calculation based sparse data using artificial neural network according to claim 2,
wherein the first location information is generated as a matrix with the same size as the input data.

4. The method of convolution calculation based sparse data using artificial neural network according to claim 3,
wherein the first location information includes a first kernel mapping information in which the computable row information is organized by point.

5. The method of convolution calculation based sparse data using artificial neural network according to claim 4,
wherein the first location information includes a first input mapping information including information on the valid data corresponding to the first kernel mapping information.

6. The method of convolution calculation based sparse data using artificial neural network according to claim 5,
wherein the second location information generating step generates the computable column information based on the first kernel mapping information, the size of the kernel, and the index information.

7. The method of convolution calculation based sparse data using artificial neural network according to claim 6,
wherein the second location information includes a second kernel mapping information in which the computable row information and the computable column information are configured for each point.

8. The method of convolution calculation based sparse data using artificial neural network according to claim 7,
wherein the second location information includes a second input mapping information including information on the valid data corresponding to the second kernel mapping information.

9. The method of convolution calculation based sparse data using artificial neural network according to claim 8,
wherein the operation rule generation step includes a step of generating a rule that matches the second kernel mapping information and the second input mapping information for each point of the convolution operation output data, and then performing a convolution operation based on the rule.

10. The method of convolution calculation based sparse data using artificial neural network according to claim 3,
wherein the kernel includes a matrix of size 3×3, 4×4 or 5×5.

11. A method of convolution operation based sparse data using artificial neural network that performs convolution operations using processor and memory comprising:
an input data collection step of collecting an information on a valid data related to rows of an output data by performing a convolution operation on an input data by dividing the information by rows of the output data;
an extended row information generation step of generating extended row information and an input index information for the valid data based on a column information where the valid data is located within the range of input data corresponding to the movement path of a kernel;
an operation rule generation step of generating a location information of output data based on the extended row information and a convolution operation rule based on the input index information, the extended row information, and the location information; and
a convolution operation step of performing a convolution operation based on the operation rule.

12. The method of convolution calculation based sparse data using artificial neural network according to claim 11,
wherein the input data collection step includes a step of collecting input data for overlapping rows using data that has already been collected, considering location information between the row for which input data is to be collected and the row for which input data has already been collected.

13. The method of convolution calculation based sparse data using artificial neural network according to claim 12,
wherein the input data collection step includes a step of sequentially collecting and storing the input data for overlapping rows through a pipeline.

14. The method of convolution calculation based sparse data using artificial neural network according to claim 11, further comprising an index information extraction step performed before the input data collection step, and
wherein the index information extraction step includes a step of extracting index information, which is location information about valid data in which data exists and invalid data in which data does not exist, within the input data.

15. The method of convolution calculation based sparse data using artificial neural network according to claim 14,
wherein the index information extraction step extracts index information using CSR FORMAT information.

16. The method of convolution calculation based sparse data using artificial neural network according to claim 11,
wherein the extended row information generation step includes a step of sequentially generating the extended row information at each corresponding column location, starting from the valid data located in the smallest column among the valid data existing within the range of input data corresponding to the movement path of the kernel.

17. The method of convolution calculation based sparse data using artificial neural network according to claim 16,
wherein the extended row information generation step includes a step of collecting index information for valid data located in the smallest column among valid data existing within the range of input data corresponding to the movement path of the kernel, divided by row.

18. The method of convolution calculation based sparse data using artificial neural network according to claim 11,
wherein the operation rule generation step includes an output index information generation step of generating a reference output index information corresponding to the input index information included in the extended row information.

19. The method of convolution calculation based sparse data using artificial neural network according to claim 18,
wherein the output index information generation step includes a step of generating the output index information by expanding it left and right based on the size of the kernel.

20. The method of convolution calculation based sparse data using artificial neural network according to claim 19,
wherein the kernel includes a matrix of size 3×3, 4×4 or 5×5.
